(19) United States
(12) Patent Application Publication
(10) Pub. No.: US 2023/0067786 A1
(43) Pub. Date: Mar. 2, 2023

(54) HERMETICALLY PACKAGED SCANNING MIRROR IN LOW HUMIDITY ENVIRONMENT AND MANUFACTURING METHOD THEREOF

(71) Applicant: COMPERTUM MICROSYSTEMS INC., Hsin-chu City (TW)

(72) Inventor: FRANCIS PIU MAN, Lexington, MA (US)

(21) Appl. No.: 17/462,012

(22) Filed: Aug. 31, 2021

(51) Int. Cl. G02B 26/10; G02B 26/08; G02B 27/00

(52) U.S. Cl. CPC G02B 26/10; G02B 26/0833; G02B 27/0006

(57) ABSTRACT

A scanning mirror apparatus, including a hermetic package having a cavity formed therein; a micro-mirror device with a reflective mirror surface disposed within the cavity; a gaseous species with pressure and with humidity content less than a predetermined index value disposed within the cavity; an optical transparent window disposed on the hermetic package bonded by glass frit bonding or metal bonding covering the internal cavity, the optical transparent window containing the gaseous species inside the internal cavity; and at least one metal pin for providing a signal, power, or ground to the micro-mirror device, attached to the hermetic package by glass frit bonding.

### BACKGROUND OF THE INVENTION

### 1. Field of the Invention

The present disclosure relates generally to scanning mirror technology, and more particularly to a scanning mirror that is hermetically packaged and a method of manufacturing thereof.

### 2. Description of the Related Art

Micro-electro-mechanical systems (MEMS) micro-mirrors have many optical applications such as in optical switches, optical cross connections, and optical mirror scanning devices.

Refer to FIG. 1A, which is a drawing illustrating an electromagnetic-driven one axis MEMS micro-mirror device 1 of the prior art. The one axis MEMS micro-mirror device 1 has a micro-mirror surface 8 disposed on top of a movable micro-mirror 4, where the micro-mirror 4 is supported on the substrate 2 by two flexures 3a, 3b. The two flexures 3a and 3b are coaxially aligned along a flexure axis 7. A coil 5 is disposed on the micro-mirror 4. When a current ‘i’ is applied to the coil 5 through pads 9a and 9b under the influence of an external magnetic field (not shown), the micro-mirror 4 rotates about the flexure axis 7 along the length of the flexure.

Refer to FIG. 1B, which is a drawing illustrating a schematic illustration of a two-dimensional MEMS micro-mirror of the prior art. The figure shows an electromagnetic-driven two axis MEMS micro-mirror device 20 having a micro-mirror surface 8 disposed on top of a movable micro-mirror 4, where the micro-mirror is supported on the gimbal 2 by two first flexures 3a, 3b suspended in a cavity 6. The two first flexures 3a and 3b are coaxially aligned along a first flexure axis 7. The gimbal 2 is in turn supported by two second flexures 13a, 13b on a substrate 90. The two flexures 13a and 13b are coaxially aligned along a second flexure axis 17. A first coil 5 is disposed on the micro-mirror 4. When a current ‘i’ is applied to the first coil 5 through first pads 9a and 9b under the influence of an external magnetic field (not shown), the micro-mirror 4 pivots about the first flexure axis 7. A second coil 15 is disposed on the gimbal 2. When a current ‘i’ is applied to the second coil 15 through second pads 19a and 19b under the influence of an external magnetic field (not shown), the micro-mirror 4 pivots about the second flexure axis 17.

Normally such a MEMS mirror will be packaged in an apparatus sealing the covered window with ambient air to eliminate dust and particle contamination. An example of a MEMS mirror apparatus is described by J. J. Bernstein, et al., Journal of Microelectromechanical Systems, Vol. 13, No. 3, June 2004, p. 526-535, “Electro-magnetically actuated mirror arrays for use in 3-D optical switching applications”.

Refer to FIG. 2, which shows an exploded view of the package used to mount the MEMS mirror to the magnet assembly 220. The magnet assembly 220 is mounted onto a magnet support plate 210 to form a magnet sub-assembly and a MEMS chip 230 is attached to the MEMS support plate 250 using a compliant adhesive which is then assembled into a cutout of a printed circuit board 260 to form a MEMS chip sub-assembly. Both magnet sub-assembly and MEMS chip sub-assembly are assembled together and then followed by attachment of a cover window 240 forming the MEMS mirror apparatus 200. The cover window 240 is placed above the MEMS mirror to allow incident laser to enter the cover window 240, reflect off the MEMS mirror and exit through the cover window 240.

However, such an apparatus is not hermetically sealed and causes humidity reliability issues when exposed to harsh weather conditions such as extreme temperatures and high humidity (such as an 85° C., 85% humidity condition). Moisture intrusion or small moisture droplets can condense onto the MEMS mirror surface or on the inside surface of the cover window when there is an abrupt change in temperature between the apparatus cavity and the environment. Droplet condensation on optical surfaces is detrimental to micro-mirror performance since it modifies the optical path of the apparatus and can damage or destroy the MEMS micro-mirror.

There is still a humidity reliability issue even if the apparatus is sealed hermetically. This is because the air in the sealed apparatus cavity is not humidity-free and any temperature change can induce droplet condensation from the air in the sealed cavity.

Therefore, it is desirable to hermetically package such a MEMS mirror in a substantially-low humidity gaseous species in order to prevent reliability issues due to humidity.

### BRIEF SUMMARY OF THE INVENTION

In one aspect, the present invention provides a scanning mirror apparatus, including a hermetic package having a cavity formed therein; a micro-mirror device with a reflective mirror surface disposed within the cavity; a gaseous species with pressure and with humidity content less than a predetermined index value disposed within the cavity; an optical transparent window disposed on the hermetic package bonded by glass frit bonding or metal bonding covering the internal cavity, the optical transparent window containing the gaseous species inside the internal cavity; and at least one metal pin for providing a signal, power, or ground to the micro-mirror device, attached to the hermetic package by glass frit bonding.

In some embodiments, the magnet assembly is disposed within the cavity. In other embodiments, the magnet assembly is disposed outside of the cavity.

In an embodiment, the predetermined index value of humidity is 10%. In an embodiment, the predetermined index value is 1%. In an embodiment, the predetermined index value is 0.1%.

In an embodiment, the predetermined pressure level of the gaseous species is atmospheric pressure. In an embodiment, the predetermined index value is below 5 bar. In an embodiment, the predetermined index value is below 10 mbar. In an embodiment, the predetermined index value is below 0.1 mbar.

In an embodiment, the scanning mirror apparatus further comprising a magnet assembly magnetically coupled to the micro-mirror device, wherein the magnet assembly comprises a plurality of individual magnets. In an embodiment, the micro-mirror device comprises a plurality of micro-mirrors.

In some embodiments, the hermetic package comprises a plurality of hermetic package pieces bonded together by welding. In various embodiments the hermetic package comprises nickel iron alloy material such as, for example, ASTM F15 alloy, 52 alloy, 48 alloy, 46 alloy, 42 alloy, or 36 alloy or ceramic material such as, for example, alumina, aluminum nitride, silicon carbide, or silicon nitride.

The optical transparent window comprises, for example, borosilicate glass, silica glass quartz, sapphire, borosilicate glass, borosilicate crown glass, or soda-lime glass. The optical transparent window is transparent to ultra-violet (340-400 nm), visible light, infra-red (840, 905, 940, 1310, 1550 nm, or 3-5 μm, 7.5-14 μm wavelengths. The glass frit bonding comprises lead-free glass frit bonding or lead-included glass frit bonding.

The metal bonding comprises, for example, metal diffusion bonding of copper-copper (250-400° C.), gold-gold (250-400° C.), titanium-titanium (300-400° C.), aluminum-aluminum (400-480° C.), silicon-titanium or metal eutectic bonding of Indium-Tin (118° C.), gold indium (180-210° C.), copper-tin (240-270° C.), gold-tin (280-310° C.), gold-germanium (380-400° C.), gold-silicon (390-415° C.), aluminum-germanium (430-450° C.), or gold-copper (450-485° C.).

In an embodiment the present invention the scanning mirror apparatus is a one dimensional device comprising a substrate; and at least one flexure coupled with the substrate and the micro-mirror device, the at least one flexure allowing the micro-mirror device to rotate about the at least one flexure. In an embodiment, the scanning mirror apparatus further comprises a magnet assembly magnetically coupled to the micro-mirror device, the magnetic assembly configured to generate a magnetic field substantially perpendicular to an axis of rotation of the at least one flexure; and at least one coil fixed to the micro-mirror device, wherein when a current is applied to the at least one coil, the micro-mirror device and the at least one coil rotate about the at least one flexure. In an embodiment, the scanning mirror apparatus further comprises: at least one angle sensor disposed on the flexure and configured to measure an angle of rotation of the micro-mirror device about the at least one flexure. In an embodiment, the scanning mirror apparatus the at least one angle sensor comprising a piezo-resistive sensor or a plurality of piezo-resistive elements coupled in a Wheatstone bridge circuit or a Hall-effect sensor.

In another embodiment of the present invention the scanning mirror apparatus is a two dimensional device and further comprises: a gimbal; at least one first flexure coupled with the micro-mirror device and the gimbal allowing the micro-mirror device and the gimbal to rotate about the at least one first flexure; a substrate; and at least one second flexure coupled with the gimbal and the substrate allowing the micro-mirror device and the gimbal to rotate about the at least one second flexure; wherein the at least one second flexure is substantially orthogonal to the at least one first flexure.

In one embodiment, the scanning mirror apparatus further comprises a first angle sensor disposed on the first flexure configured to measure a first angle of rotation of the micro-mirror device about the first flexure; and a second angle sensor disposed on the second flexure configured to measure a second angle of rotation of the micro-mirror device about the second flexure. The first and second angle sensor comprises, for example, a piezo-resistive sensor or a plurality of piezo-resistive elements coupled in a Wheatstone bridge circuit or a Hall-effect sensor.

In an embodiment the scanning mirror apparatus further comprises: a magnet assembly magnetically coupled to the micro-mirror device, wherein the magnetic assembly is configured to generate a first magnetic field substantially perpendicular to an axis of rotation of the at least one first flexure and a second magnetic field substantially perpendicular to an axis of rotation of the at one second flexure; at least one first coil fixed to the micro-mirror device, wherein when a first current is applied to the at least one first coil, the micro-mirror device and the at least one first coil rotate about the first flexure; and at least one second coil fixed to the gimbal, wherein when a second current is applied to the at least one second coil, the micro-mirror device, the gimbal, and the at least one second coil rotate about the second flexure.

In another embodiment, the scanning mirror apparatus further comprises a magnet assembly magnetically coupled to the micro-mirror device, wherein the magnetic assembly is configured to generate a first magnetic field substantially perpendicular to an axis of rotation of the at least one first flexure and a second magnetic field substantially perpendicular to an axis of rotation of the at one second flexure; at least one first coil fixed to the gimbal, wherein when a first current is applied to the at least one first coil, the micro-mirror device and the at least one first coil rotate about the first flexure; and at least one second coil fixed to the gimbal, wherein when a second current is applied to the at least one second coil, the micro-mirror device, the gimbal, and the at least one second coil rotate about the second flexure.

In yet another embodiment, the scanning mirror apparatus further comprises a magnet assembly magnetically coupled to the micro-mirror device, wherein the magnetic assembly is configured to generate a first magnetic field substantially perpendicular to an axis of rotation of the at least one first flexure and a second magnetic field substantially perpendicular to an axis of rotation of the at one second flexure; and at least one coil fixed to the gimbal, wherein when a first current is applied to the at least one coil, the micro-mirror device and the at least one coil rotate about the first flexure; and when a second current is also applied to the at least one coil, the micro-mirror device, the gimbal, and the at least one coil rotate about the second flexure.

In one embodiment, the scanning mirror apparatus comprises at least one electrostatic driven micro-electro-mechanical systems (MEMS) micro-mirror further comprising a plurality of first flexure comb electrodes electrically coupled to the scanning mirror; corresponding counterparts of the first flexure comb electrodes electrically coupled to the gimbal; a first isolation layer disposed between the first flexure and the gimbal that electrically isolated the first flexure and the gimbal; and a plurality of second flexure comb electrodes electrically coupled to the gimbal; corresponding counterparts of the second flexure comb electrodes electrically coupled to a device layer which is electrically insulated from the substrate by a second isolation layer disposed in between; wherein when an AC voltage is applied to the micro-mirror device, the micro-mirror rotates about the second flexure while the gimbal is connected to electrical ground; and wherein when another AC voltage is applied to the device layer, the scanning mirror rotates about the first flexure.

In another embodiment, the scanning mirror apparatus comprises at least one piezo-electric driven micro-electro-mechanical systems (MEMS) micro-mirror further comprising a first piezoelectric actuator such that when a first AC voltage of substantially close to resonant frequency is applied to the first piezoelectric actuator, the micro-mirror rotates about the first flexure; and a second piezoelectric actuator such that when a second AC voltage of substantially close to resonant frequency is applied to the second piezoelectric actuator, the micro-mirror rotates about the second flexure.

In other embodiment, the scanning mirror apparatus further comprises a moisture absorption moiety comprising silica gel, molecular sieve, calcium chloride, calcium montmorillonite, H2O getter, Zirconium alloy, calcium oxide or combination thereof.

In another embodiment, the disclosure includes a method of making a scanning mirror apparatus comprising providing a hermetic package having an internal cavity formed therein; disposing a micro-mirror device with a reflective mirror surface disposed inside the internal cavity; disposing a gaseous species with predetermined value of humidity content and pressure disposed inside the internal cavity; disposing an optical transparent window disposed on the hermetic package bonded by glass frit bonding or metal bonding covering the internal cavity, the optical transparent window containing the gaseous species inside the internal cavity; and disposing at least one metal pin for providing a signal, power, or ground to the micro-mirror device, attached to the hermetic package by glass frit bonding.

In an embodiment, the scanning mirror apparatus further comprises a magnet assembly magnetically coupled to the micro-mirror device, wherein the magnet assembly is disposed inside the internal cavity. In another embodiment, the scanning mirror apparatus further comprises a magnet assembly magnetically coupled to the micro-mirror device, wherein the magnet assembly is disposed outside the internal cavity. The predetermined value of pressure level of the gaseous species is, for example, below 5 bar.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1A is a schematic illustration of a one-dimensional MEMS micro-mirror of the prior art.

FIG. 1B is a schematic illustration of a two-dimensional MEMS micro-mirror in the prior art.

FIG. 2 is an exploded view of the package used to mount the MEMS mirror to the magnet assembly of the prior art.

FIG. 3A is a perspective schematic illustration of a one-dimensional MEMS apparatus according to an embodiment of the present invention.

FIG. 3B is a plain schematic illustration of the one-dimensional MEMS apparatus as shown in FIG. 3A according to an embodiment of the present invention.

FIG. 4A is a perspective schematic illustration of a two dimensional MEMS micro-mirror according to an embodiment of the present invention.

FIG. 4B is a plain schematic illustration of the two-dimensional MEMS apparatus as shown in FIG. 4A according to an embodiment of the present invention.

FIG. 4C shows a two dimensional micro-mirror device coupling with a first piezo-resistive sensor disposed on a first flexure and a second piezo-resistive sensor disposed on a second flexure according to an embodiment of the present invention.

FIG. 5 is a schematic illustration of a two dimensional MEMS micro-mirror with a laser and position sensing detector according to an embodiment of the present invention.

FIG. 6 shows the operation of a two dimensional MEMS micro-mirror with a laser and position sensing detector according to an embodiment of the present invention.

FIG. 7A shows a cross sectional schematic of a wafer-level hermetic bonding of a MEMS micro-mirror according to an embodiment of the present invention.

FIG. 7B shows a cross sectional schematic of a ceramic packaging technology of a MEMS micro-mirror according to an embodiment of the present invention.

FIG. 7C shows a cross sectional schematic of a MEMS apparatus 730 according to an embodiment of the present invention.

FIG. 7D shows a cross sectional schematic of a MEMS apparatus 750 according to an embodiment of the present invention.

FIG. 7E shows a cross sectional schematic of a MEMS apparatus 790 according to an embodiment of the present invention.

FIG. 7F shows a metal screw sealing gasket and its sealing mechanism according to an embodiment of the present invention.

FIG. 7G shows a cross sectional schematic of a MEMS apparatus 770 according to an embodiment of the present invention.

FIG. 7H shows a cross sectional schematic of a MEMS apparatus 780 according to an embodiment of the present invention.

FIG. 7I shows a cross sectional schematic of a MEMS apparatus 788 according to an embodiment of the present invention.

FIG. 8A is a process flow diagram showing a method of making the MEMS package 730 according to an embodiment of the present invention.

FIG. 8B is a process flow diagram showing a method of making the MEMS package 770 according to an embodiment of the present invention.

FIG. 8C is a process flow diagram showing a method of making the MEMS package 750 according to an embodiment of the present invention.

FIG. 8D is a process flow diagram showing a method of making the MEMS package 780 according to an embodiment of the present invention.

FIG. 8E is a process flow diagram showing a method of making the MEMS package 790 according to an embodiment of the present invention.

FIG. 8F is a process flow diagram showing a method of making the MEMS package 788 according to an embodiment of the present invention.

FIG. 9A shows a flowchart showing a method of making the MEMS package 730 according to an embodiment of the present invention.

FIG. 9B shows a flowchart of a method of making the MEMS package 770 according to an embodiment of the present invention.

FIG. 9C shows a flowchart of a method of making the MEMS package 750 according to an embodiment of the present invention.

FIG. 9D shows a flowchart of a method of making the MEMS package 780 according to an embodiment of the present invention.

FIG. 9E shows a flowchart of a method of making the MEMS package 790 according to an embodiment of the present invention.

FIG. 9F shows a flowchart of a method of making the MEMS package 788 according to an embodiment of the present invention.

FIG. 10 is a schematic illustration of an electro-optical device according to an embodiment of the present invention.

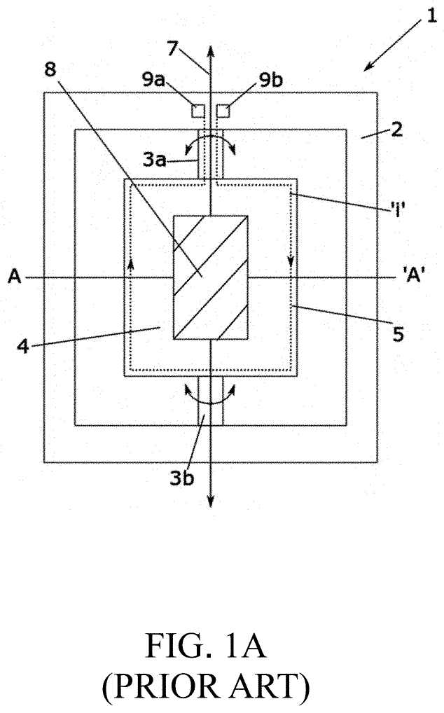

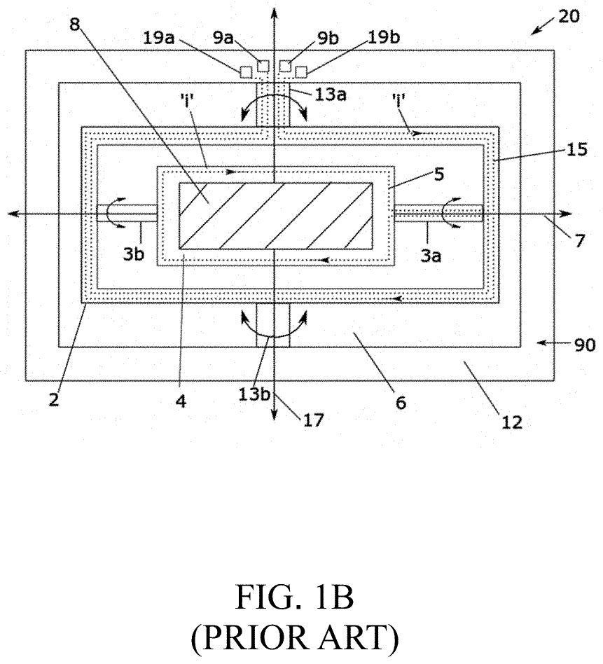

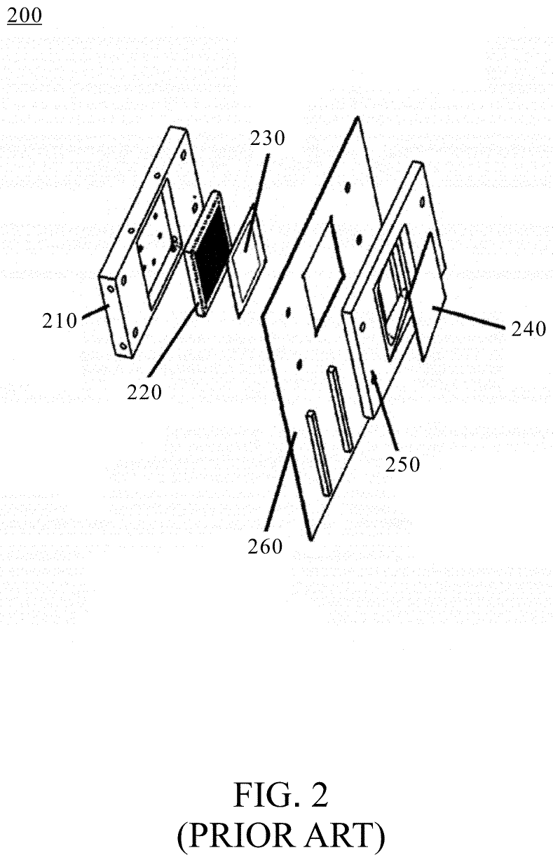

### DETAILED DESCRIPTION OF THE INVENTION

To facilitate understanding of the object, characteristics and effects of this present disclosure, embodiments together with the attached drawings for the detailed description of the present disclosure are provided.

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

The description will be made as to the embodiments of the present invention in conjunction with the accompanying drawings. In accordance with the purposes of this invention, as embodied and broadly described herein, this invention, in one aspect, relates to an injection molding machine device.

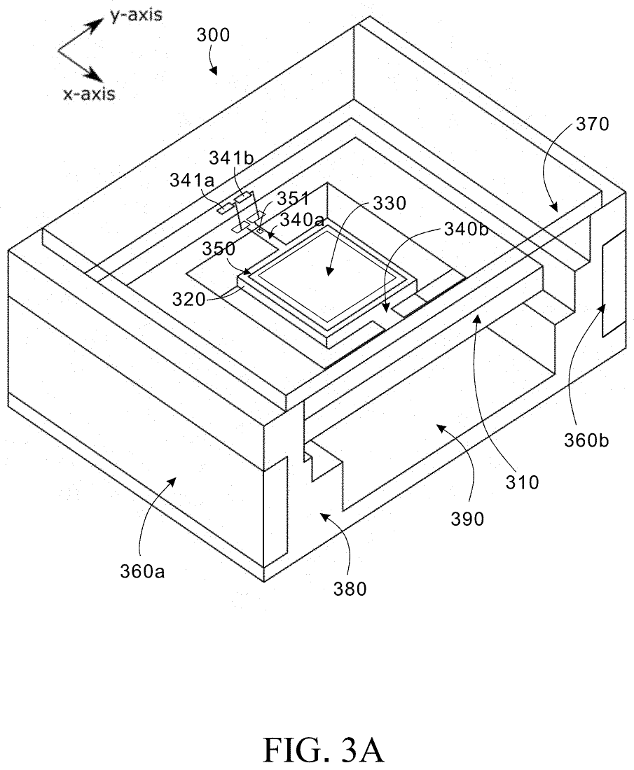

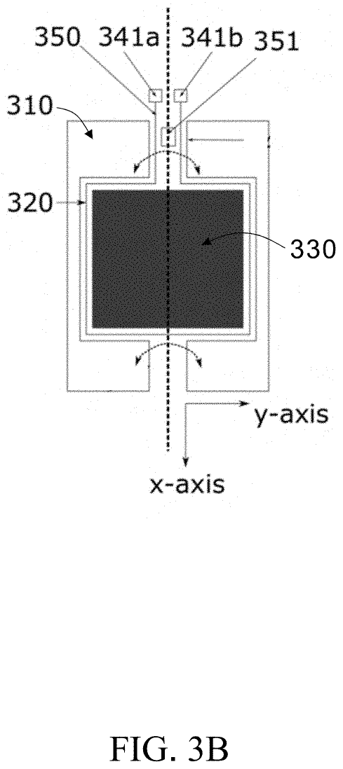

Refer to FIGS. 3A and 3B which schematically show a MEMS apparatus 300 according to an embodiment of the present invention. The MEMS apparatus 300 is in the form of a hermetic package with at least one transparent window 370, which has a cavity 390 formed therein. A MEMS micro-mirror device is disposed within the cavity 390. A gaseous species with substantially low humidity is disposed within the cavity 390 and at least partially surrounding a portion of the micro-mirror device. A magnet assembly, which is formed by a plurality of individual magnets 360a, 360b, is magnetically coupled with the micro-mirror device.

As shown in FIG. 3A, the MEMS micro-mirror device includes a substrate 310, a micro-mirror 320 having a reflective micro-mirror surface 330 disposed thereon, two flexures 340a, 340b along the X-axis, and at least a coil 350 fixed to the micro-mirror 320. The micro-mirror 320 is suspended by the two flexures 340a, 340b to the substrate 310. Such micro-mirror 320 is driven by an electromagnetic mechanism, which is formed by the at least one coil 350 disposed on the micro-mirror device. A current is passed through the at least one coil 350 causing the micro-mirror 320 to rotate about the flexures 340a, 340b along the X-axis under the influence of an external magnetic field substantially orthogonal (along the Y-axis) to the two flexures 340a, 340b, where the external magnetic field is generated by the magnetic assembly formed by the individual magnets 360a, 360b disposed in the vicinity of the mirror device. The coil 350 is connected externally through pads (341a, 341b). An angle sensor 351 is disposed on the flexure 340a and configured to measure an angle of rotation of the micro-mirror device about the flexure 340a.

The micro-mirror device is exposed at least partially to a gaseous species disposed within the cavity 390 of the hermetic package body 380. The gaseous species may be but not limited to nitrogen, carbon dioxide, sulfur hexafluoride, propane, nitrogen dioxide or inert gaseous species such as argon, neon, helium, and xenon. In an embodiment the gaseous species has low humidity that is lower than 10%. In an embodiment the gaseous species has low humidity that is lower than 5%. In an embodiment the gaseous species has low humidity that is lower than 1%. In an embodiment the gaseous species has zero humidity. In an embodiment H₂O getter is disposed within the cavity to reduce humidity. In an embodiment, a moisture absorption moiety is disposed within the cavity to reduce or control humidity. Such moisture absorption moiety comprises silica gel, molecular sieve, calcium chloride, calcium montmorillonite, H₂O getter, Zirconium alloy, calcium oxide or combination thereof.

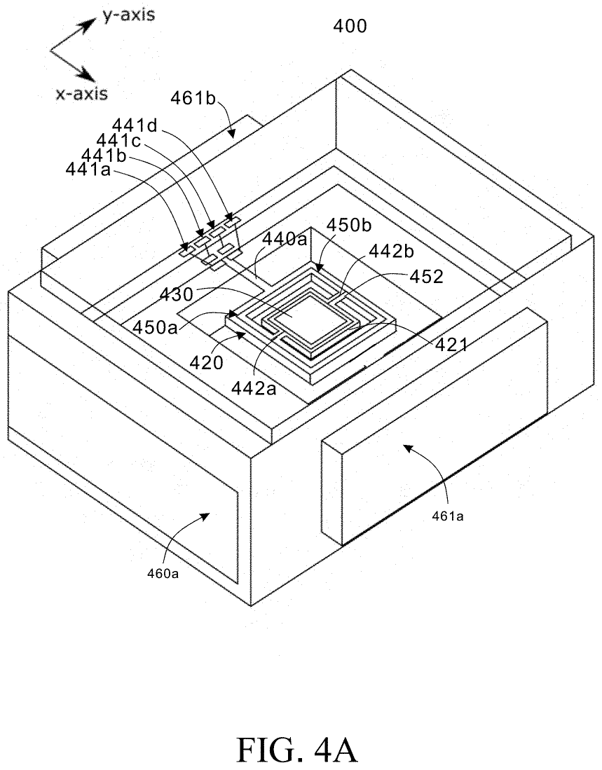

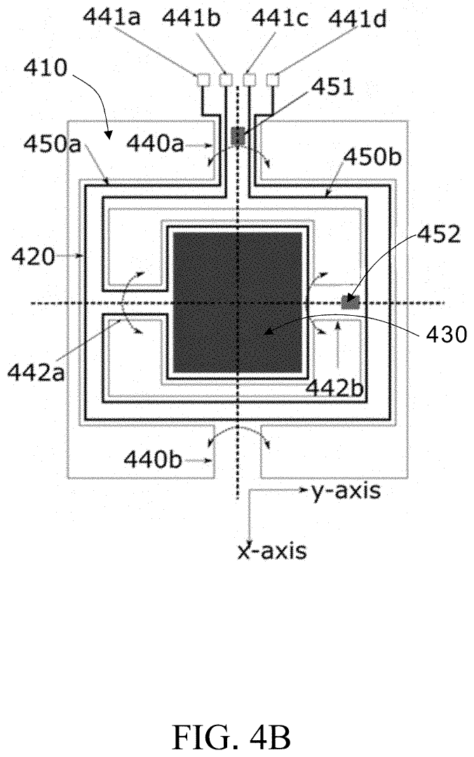

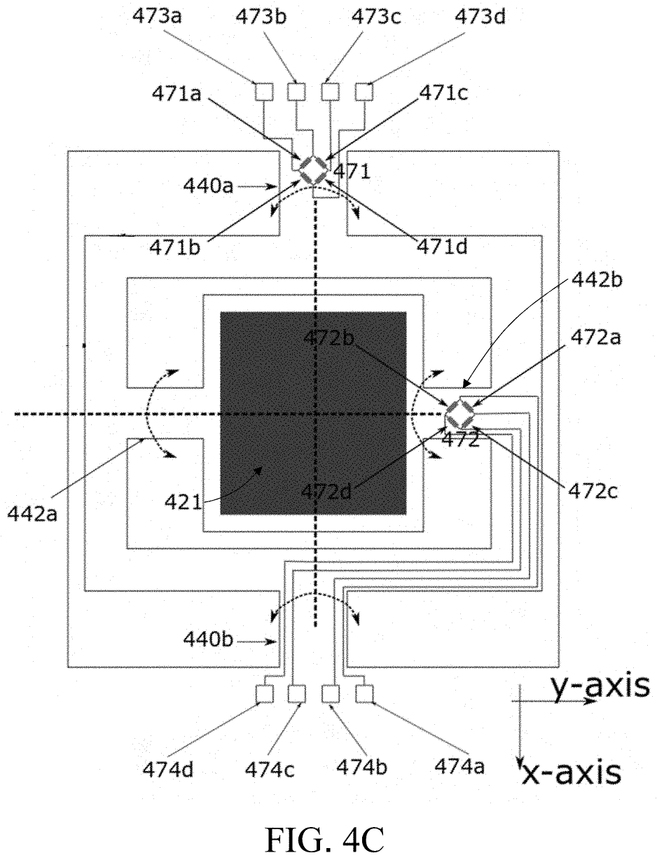

Refer to FIGS. 4A and 4B which schematically show a MEMS apparatus 400 according to an embodiment of the present invention. The MEMS apparatus 400 is in the form of a hermetic package with at least one transparent window, which has a cavity formed therein. A micro-electro-mechanical (MEMS) micro-mirror device is disposed within the cavity. A gaseous species with substantially low humidity is disposed within the cavity and at least partially surrounding a portion of the micro-mirror device. A magnet assembly, which is formed by a plurality of individual magnets 460a, 460b, 461a, 461b, is magnetically coupled with the micro-mirror device.

As shown in FIGS. 4A and 4B, the micro-mirror device includes a substrate 410; a gimbal 420; a micro-mirror 421; a reflective mirror surface 430 disposed on the micro-mirror 421, two first flexures (442a, 442b) coupled with the micro-mirror 421 and the gimbal 420; two second flexures (440a, 440b) coupled with the gimbal 420 and the substrate 410; at least one first coil 450a fixed to the micro-mirror 421; and at least one second coil 450b fixed to the gimbal 420. When a first current is applied to the first coil 450a via conductive pads 441a, 441b, 441c, 441d, the magnetic assembly (461a, 461b) generates a first magnetic field and the micro-mirror 421 and the first coil 450a rotate about the first flexures (442a, 442b) in response to the first magnetic field. When a second current is applied to the second coil 450b, the magnetic assembly (460a, 460b) generates a second magnetic field and the micro-mirror 421, the gimbal 420 and the second coil 450b rotate about the second flexures (440a, 440b) in response to the second magnetic field.

In another embodiment, the scanning mirror apparatus 400 comprises at least one piezo-electric driven micro-electro-mechanical systems (MEMS) micro-mirror. In this embodiment one or more of the plurality of conductive pads (441a, 441b, 441c, or 441d) comprise a first piezoelectric actuator such that when a first AC voltage of substantially close to resonant frequency is applied to the first piezoelectric actuator, the micro-mirror rotates about the first flexure (442a, 442b); and one or more of the plurality of conductive pads (441a, 441b, 441c, or 441d) comprise a second piezoelectric actuator such that when a second AC voltage of substantially close to resonant frequency is applied to the second piezoelectric actuator, the micro-mirror rotates about the second flexure (440a, 440b).

In certain embodiments, the micro-mirror device further comprises at least one first angle sensor 451 disposed on the first flexures (442a, 442b) and another at least one second angle sensor 452 disposed on the second flexures (440a, 440b). The first angle sensor is configured to measure the torsional stress of the first flexure as the micro-mirror 421 rotates thus corresponding to a first angle of rotation of the micro-mirror about the first flexures (442a, 442b). Similarly, the second angle sensor is configured to measure the torsional stress of the second flexure as the micro-mirror 421 rotates thus corresponding to a second angle of rotation of the micro-mirror 421 about the second flexures (440a, 440b). Each of the first angle sensor and the second angle sensor may be formed by a piezo-resistive sensor or a Hall-effect sensor.

In certain embodiments, the piezo-resistive sensor is formed by a plurality of piezo-resistive elements coupled in a Wheatstone bridge circuit disposed on the flexure to detect torsional flexing about the axis of the flexure. Refer to FIG. 4C, which shows a two dimensional micro-mirror device coupling with a first piezo-resistive sensor (471) disposed on a first flexure 440a and a second piezo-resistive sensor (472) disposed on a second flexure 442b according to one embodiment of the disclosure. As shown in FIG. 4C, the first piezo-resistive sensor (471) comprises a plurality of first piezo-resistive elements (471a, 471b, 471c, 471d) in a Wheatstone bridge circuit, where all four elements have substantially identical resistance. Similarly, the second piezo-resistive sensor (472) comprises a plurality of second piezo-resistive elements (472a, 472b, 472c, 472d) in a Wheatstone bridge circuit where all four elements have substantially identical resistance. A voltage is biased to the Wheatstone bridge between first conductive pads 473b and 473d, and a differential potential is measured between first conductive pads 473a, and 473c. When the micro-mirror does not rotate, no differential potential is measured. As the micro-mirror (421) rotates along first flexure (440a), the first flexure experiences change in torsional stress and the resistance of piezo-resistive elements changes such that resistance of the piezo-resistive elements (471a, and 471d) changes while resistance of piezo-resistive elements (471b, and 471c) change in the opposite direction. As a result, a differential potential is measured corresponding to the angle of rotation along the first flexure. Similarly, a second piezo-resistive sensor (472) is disposed on the second flexure 442b comprising a plurality of piezo-resistive elements (472a, 472b, 472c, 472d) in a Wheatstone bridge circuit where all four elements have substantially identical resistance. When a voltage is biased between second conductive pads 474b and 474d, no potential difference is measured between second conductive pads 474a and 474c. When the micro-mirror 421 rotates along the second flexure (442b), the second flexure experiences a change in torsional stress causing a differential potential between 474b and 474d which corresponds to the angle of rotation along the second flexure 442b. Additional piezo-resistive sensors could also be disposed on flexure 440b and 442a to improve angle sensitivity.

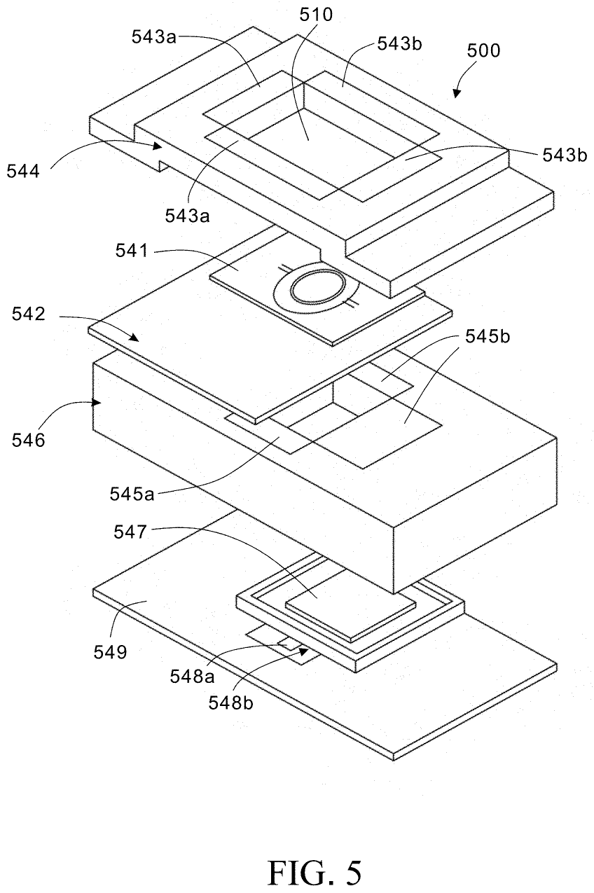

In certain embodiments, angle sensors are also displaced external to the MEMS chip. Refer to FIG. 5, which shows a MEMS apparatus 500, which comprises a MEMS micro-device (541) sitting on a substrate (542), a plurality of magnets (543a, 543b, 545a, 545b) sitting on a fixture (544, 546), and an on-package angle sensor on a printed circuit board (549) including a light source 548a that could be a light emitting diode (LED), laser source or Vertical-Cavity Surface-Emitting Laser (VCSEL); and a fixture 548b band optical angle sensor 547. Magnets 543a, 543b, 545a, and 545b are configured to form a magnetic field leaving a cavity 510 for the micro-mirror to rotate. The fixture 548b defines the tilting angle of the light source such that the light source points to the backside surface of the MEMS mirror.

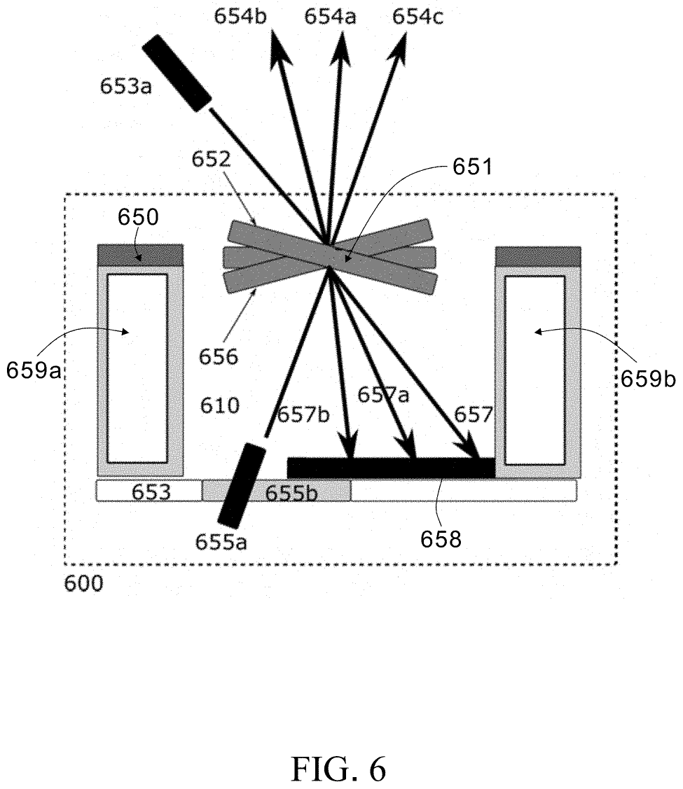

Refer to FIG. 6, which shows the operation of the on-package optical angle sensor of the micro-mirror device 600, wherein the light source 655a on a substrate 655b on a fixture base 653 in the cavity 610 emits a light that reflects off the micro-mirror surface 656 on the back side of the micro-mirror device 651 and reaches the optical angle sensor 658 such that the optical angle sensor 658 measures the rotating angle of the micro-mirror device 651 about the first flexure and the second flexure (not shown in FIG. 6). Specifically, the optical angle sensor 658 detects the position of the light hitting the sensor surface (657, 657a, 657b) which corresponds to the angle of light reflection, and thus the rotating angle of the micro-mirror surface 656 about the first flexure and the second flexure may be obtained correspondingly. In certain embodiments, the optical angle sensor is a Position Sensitive Detector (PSD) or a Charge Coupled Device (CCD). Light from an external light source 653a can also enter and be reflected back out by the front surface 652 as reflected light (654a, 654b, 654c). Bonding material 650 is provided above the fixture containing the magnets 659a, 659b.

In an embodiment the MEMS micro-mirror device is in the form of a MEMS micro-mirror array that includes a plurality of MEMS micro-mirrors.

In order to prevent moisture intrusion, the MEMS apparatus has to be sealed hermetically. There are several conventional wafer-level hermetic bonding technologies using conventional bonding machine such as SussMicroTec SB81 or EV GROUP EVG 520 wafer bonder: anodic bonding (silicon to glass), and direct bonding (silicon to silicon, silicon to silicon oxide, silicon to silicon nitride), eutectic bonding (AlGe) and metal to metal bonding (Cu—Cu, Au—Au).

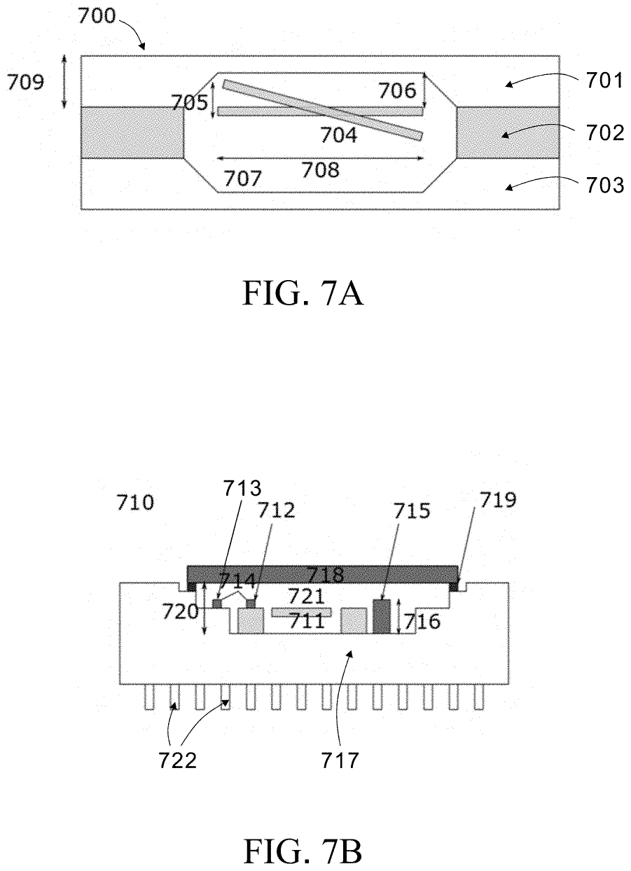

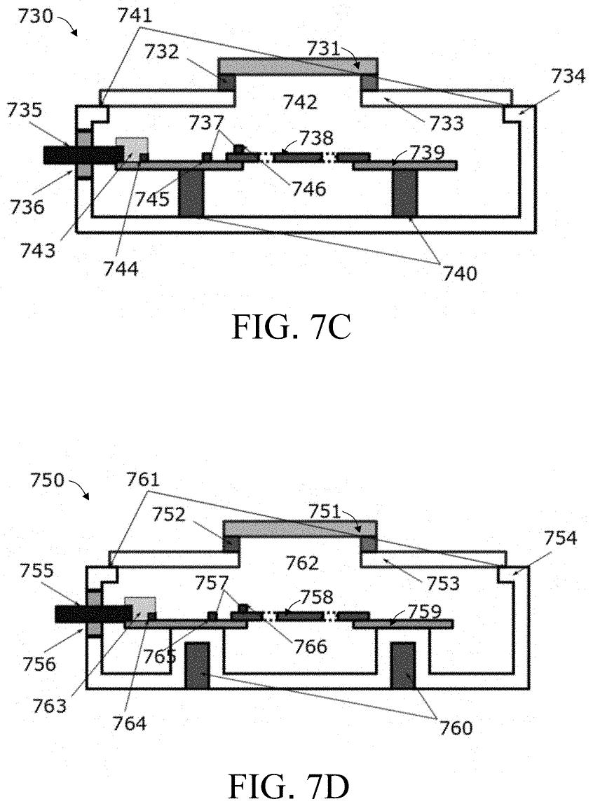

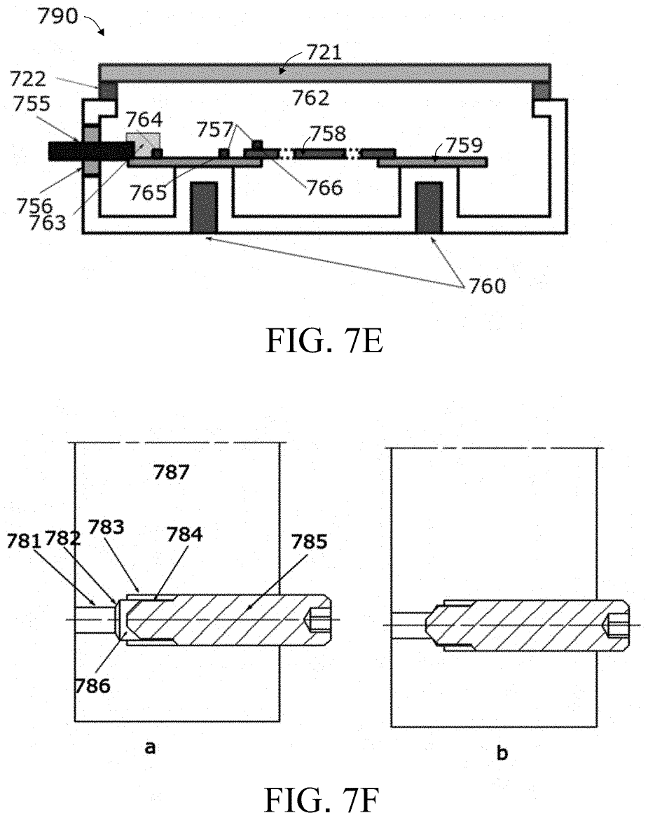

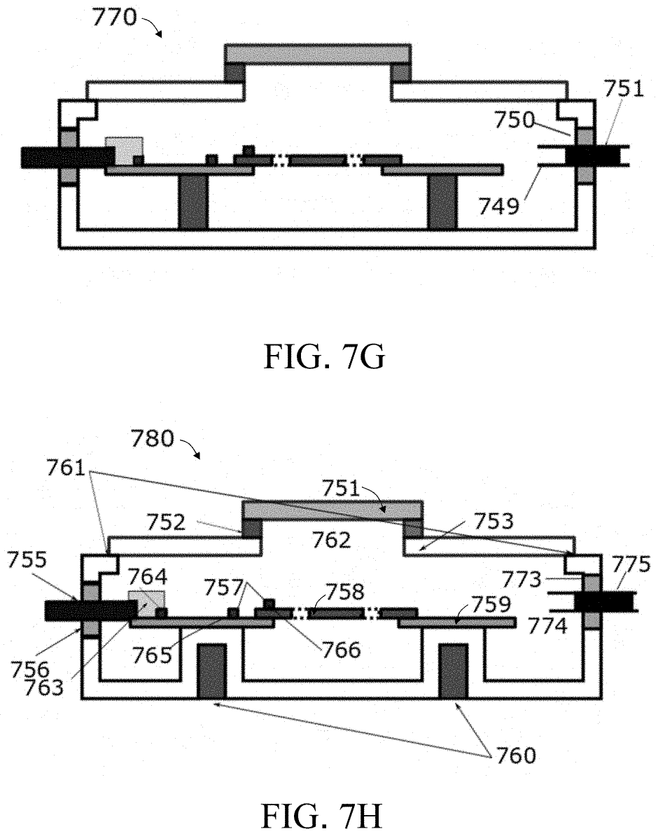

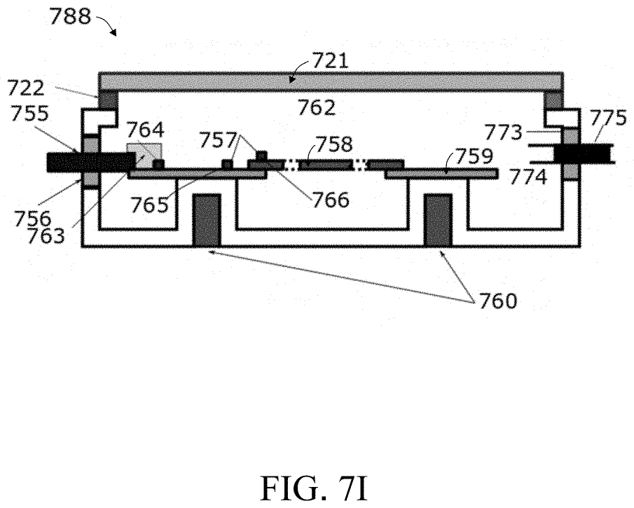

Refer to FIG. 7A, which shows the cross-sectional view of a wafer-level hermetic bonding MEMS micro-mirror device 700 comprising 1) a MEMS micro-mirror device wafer 702 with micro-mirror 704 of width 708; 2) a top glass cap wafer 701 (thickness 709) with etched cavity of depth 706; 3) a bottom silicon cap wafer 703 with etched cavity 707. All three wafers are hermetically bonded together. However, such hermetic bonding technology is not applicable to a MEMS micro-mirror chip since the micro-mirror calls for a large mirror size 708 (— several mm) and the bonding cavity does not have enough height 706 (<1 mm) for micro-mirror rotation 705. Besides wafer-level bonding technology, there is also ceramic packaging technology (FIG. 7B) on a MEMS apparatus 710 that the micro-chip 711 be disposed on a ceramic package 717, and covered hermetically with a cover window 718 using bonding material 719. The micro-chip is electrically connected from a pad 712 to a package pad 713 using wire bonding 714 and finally connected to package pins 722. However, such ceramic packaging technology is not suitable to a MEMS micro-mirror chip especially an electromagnetically driven MEMS micro-mirror chip since the MEMS apparatus has to accommodate not only the MEMS microchip but also the magnet assembly 715 with a height 716 (several mm tall) which is taller than the package cavity height 720.

TABLE 1

| | | Max. |
|---|---|---|
| | | working |
| | Remanence | temperature |
| Grade | (mT) | (° C.) |
| N55 | 14.6-15.2 | ≤60 |
| N52 | 14.4-14.8 | ≤60 |
| N50 | 14.0-14.5 | ≤80 |
| N50M | 14.0-14.5 | ≤100 |
| N48H | 13.7-14.3 | ≤120 |

Another issue about the magnet assembly is its working temperature. Table 1 shows a list of magnets with various grades, its magnetic strength and its maximum operating temperature. It can be seen that magnets with higher magnetic strength operate at lower temperature. However, hermetic bonding of the cover window on the ceramic package is done after placement of the magnet assembly, and the bonding temperature is too high for the magnet assembly causing it to degrade.

Therefore, it is imperative that the magnetic assembly be completed after all high temperature process steps: glass frit bonding and metal bonding.

Refer to FIG. 7C, which shows a cross sectional schematic of a MEMS apparatus 730 according to an embodiment of the present invention. The MEMS apparatus 730 is in the form of a hermetic package with at least one transparent window 731, which has a cavity 742 formed therein. A MEMS micro-mirror device 738 is disposed within the cavity 742. A gaseous species with substantially low humidity is disposed within the cavity 742 and at least partially surrounding a portion of the micro-mirror device. A magnet assembly, which is formed by a plurality of individual magnets 740, is magnetically coupled with the micro-mirror device. The micro-mirror device is electrically connected from a pad 746 to a pad 745 on a printed circuit board 739 by wire bonding 737 and from a pad 744 to a pin 735 through soldering 743.

The MEMS apparatus is in the form of a hermetic package with at least one transparent window. Such hermetic package can be achieved by hermetic bonding techniques or combinations thereof: glass frit bonding for the metal pin, metal bonding for the window, lead free/lead included frit glass bonding for the window, laser seam welding, and metal screw gasket for sealing.

The MEMS apparatus 730 utilizes glass frit bonding for the metal pin, metal bonding for the window or lead free/lead included frit glass bonding for the window and laser seam welding.

Glass Frit Bonding for the Metal Pin:

For hermetic sealing of the metal pin on the apparatus housing 734, glass frit bonding (as seen in FIG. 7C) is a glass to metal sealing technology that uses a glass seal 736 to seal the metal pin 735 for a signal, and power supply isolating from the apparatus housing 734. Such glass frit bonding is performed in a furnace at elevated temperature. A special glass seal 736 is used to insulate metal contacts to form an impermeable and non-aging hermetic seal such that gas and moisture cannot penetrate through the glass seal. Glass material for the glass seal 736 and metal for the contact pin 735 are selected such that their coefficients of thermal expansion match to prevent seal failure at elevated temperature.

Material for the pin can be, but not limited, to 52 Alloy, 48 Alloy, 46 Alloy, 42 Alloy, 36 Alloy, ASTM-F15 (Kovar®), copper, copper alloy and cold rolled steel (AISI 1010) plated with gold, or gold-nickel to improve pin conductivity. The apparatus housing material can be, but not limited to, 52 Alloy, 48 Alloy, 46 Alloy, 42 Alloy, 36 Alloy, ASTM-F15 (Kovar®), and cold rolled steel (AISI 1010).

A conductive seal such as copper alloy can be used instead of a glass seal to hermetically seal the metal pin with the apparatus housing to provide housing ground.

Metal Bonding for the Window:

As seen in FIG. 7C, this MEMS apparatus comprises an optical glass window 731 to allow optical signal transmission such that a laser transmits through the window 731, reflects on the MEMS micro-mirror 738 and finally transmits through the window 731 again.

The optical glass window material can be, but not limited to, CG-1, D263Teco, Quartz SK1300 sapphire, Eagle XG, N-BK7, and B270. The optical glass window can be coated with an anti-reflection coating or a band pass filter of a certain wavelength. The window 731 is patterned with metal bonding material 732 to form a hermetic bonding with the apparatus plate 733 under elevated temperature, and pressure.

The apparatus plate material can be, but not limited to, 52 Alloy, 48 Alloy, 46 Alloy, 42 Alloy, 36 Alloy, ASTM-F15 (Kovar®), and cold rolled steel (AISI 1010). These materials can be Computer Numerical Control (CNC) machined or metal injection molded or die casting. The apparatus housing can be plated with various materials such as nickel, nickel-gold not only to prevent housing rusting, but also improve metal bonding adhesion.

Bonding is not limited to metal diffusion bonding such as copper-copper (250-400° C.), gold-gold (250-400° C.), titanium-titanium (300-400° C.), aluminum-aluminum (400-480° C.), silicon-titanium and metal eutectic bonding such as Indium-Tin (118° C.), gold indium (180-210° C.), copper-tin (240-270° C.), gold-tin (280-310° C.), gold-germanium (380-400° C.), gold-silicon (390-415° C.), aluminum-germanium (430-450° C.), or gold-copper (450-485° C.).

The metal bonding material forms an impermeable and non-aging hermetic seal between the window and the apparatus plate such that gas and moisture cannot penetrate through the metal seal. The glass window 731 and the apparatus plate 733 are selected such that their coefficients of thermal expansion match to prevent seal failure at elevated temperatures. This metal bonding process can be operated under a selected gaseous environment and humidity condition. The pressure of the gaseous environment can range, for example, from 1 to 10 bar. Specifically, the pressure of the gaseous environment can range from 1 to 3 bar. More specifically, the pressure of the gaseous environment can range from 0.1 to 1 bar. The pressure of the gaseous environment can range from 10 to 100 mbar. Specifically, the pressure of the gaseous environment can range from 1 to 10 mbar. More specifically, the pressure of the gaseous environment can range from 0.1 to 1 mbar. More specifically, the pressure of the gaseous environment can range from 0.01 to 0.1 mbar.

The gaseous species can be, but not limited to, nitrogen, carbon dioxide, sulfur hexafluoride, propane, nitrogen dioxide or inert gaseous species such as argon, neon, helium, or xenon. The gaseous species can have low humidity that is lower than 10%. The gaseous species can have low humidity that is lower than 5%. The gaseous species can have low humidity that is lower than 1%. The gaseous species can have zero humidity.

Lead Free/Lead Included Frit Glass Bonding for Window:

Lead free or lead included frit glass bonding is another technology to hermetically seal the glass window to the apparatus plate in an oven under elevated temperature (460° C. for lead-free and 320° C. for lead included) and a gaseous environment.

The cover window material can be, but not limited to, CG-1, D263Teco, Quartz SK1300 sapphire, Eagle XG, N-BK7, orB270. The cover window can be coated with an anti-reflection coating or a band pass filter of a certain wavelength.

The apparatus plate material can be but not limited to 52 Alloy, 48 Alloy, 46 Alloy, 42 Alloy, 36 Alloy, ASTM-F15 (Kovar®), or cold rolled steel (AISI 1010). These materials can be Computer Numerical Control (CNC) machined or metal injection molded or die casting. The apparatus housing can be plated with various materials such as nickel or nickel-gold so as to prevent the housing rusting.

The lead-free or lead-included glass frit material forms an impermeable and non-aging hermetic seal between the window and the apparatus plate such that gas and moisture cannot penetrate through the metal seal. The glass window 731 material and the apparatus plate 733 are selected such that their coefficients of thermal expansion match in order to prevent seal failure at elevated temperatures. This lead free or lead-included glass frit bonding process can be operated under a selected gaseous environment and humidity condition. The pressure of the gaseous environment can range from 1 to 10 bar. Specifically, the pressure of the gaseous environment can range from 1 to 3 bar. More specifically, the pressure of the gaseous environment can range from 0.1 to 1 bar. The pressure of the gaseous environment can range from 10 to 100 mbar. Specifically, the pressure of the gaseous environment can range from 1 to 10 mbar. More specifically, the pressure of the gaseous environment can range from 0.1 to 1 mbar. More specifically, the pressure of the gaseous environment can range from 0.01 to 0.1 mbar. The gaseous species can be, but not limited to, air nitrogen, carbon dioxide, sulfur hexafluoride, propane, nitrogen dioxide or inert gaseous species such as argon, neon, helium, or xenon. The gaseous species can have low humidity that is lower than 10%. The gaseous species can have low humidity that is lower than 5%. The gaseous species can have low humidity that is lower than 1%. The gaseous species can have zero humidity.

Laser Seam Welding:

Laser seam welding allows hermetic bonding of metal with the same metal material. Laser seam welding can also provide hermetic bonding metal material with dissimilar metal material. As seen in FIG. 7C, the apparatus plate 733 is hermetically sealed with the apparatus housing 734 using laser seam welding at the seam 741. Unlike glass-frit bonding and metal bonding, laser welding occurs at the seam, therefore only temperature (<200° C.) is elevated at the localized seam instead of the whole apparatus so that the magnet assembly will not be degraded by localized heating. Usually the laser seam welding tool can be operated under a selected gaseous environment and humidity condition. The pressure of the gaseous environment can range from 1 to 10 bar. Specifically, the pressure of the gaseous environment can range from 1 to 3 bar. More specifically, the pressure of the gaseous environment can range from 0.1 to 1 bar. The pressure of the gaseous environment can range from 10 to 100 mbar. Specifically, the pressure of the gaseous environment can range from 1 to 10 mbar. More specifically, the pressure of the gaseous environment can range from 0.1 to 1 mbar. More specifically, the pressure of the gaseous environment can range from 0.01 to 0.1 mbar.

The gaseous species can be, but not limited to, nitrogen, carbon dioxide, sulfur hexafluoride, propane, nitrogen dioxide or inert gaseous species such as argon, neon, helium, or xenon. The gaseous species can have low humidity that is lower than 10%. The gaseous species can have low humidity that is lower than 5%. The gaseous species can have low humidity that is lower than 1%. The gaseous species can have zero humidity.

The apparatus housing material can be, but not limited to, 52 Alloy, 48 Alloy, 46 Alloy, 42 Alloy, 36 Alloy, ASTM-F15 (Kovar®), or cold rolled steel (AISI 1010). Other apparatus housing materials can also be die casting aluminum, zinc, copper, magnesium, iron plated with nickel or nickel-gold to prevent oxidation. Other apparatus housing materials can include ceramic and metal injection molding of alloys such as stainless steels, titanium, nickel, tungsten, copper or combinations thereof.

Refer to FIG. 7D, which shows a MEMS apparatus 730 sealed in an apparatus housing using glass frit bonding for the metal pin, metal bonding or lead-free/lead-included glass frit for the transparent window 731, and laser seam welding, prior to disposing the magnet assembly outside the cavity so that the magnet assembly is not degraded by prior high temperature bonding steps.

Refer to FIG. 7E, which shows a MEMS apparatus 730 sealed in an apparatus housing using glass frit bonding for the metal pin, and metal bonding or lead-free/lead-included glass frit for the transparent window prior to disposing the magnet assembly outside the cavity.

Metal Screw Gasket Sealing:

Metal screw gasket sealing is a mechanical sealing method under a gaseous environment which does not involve any high temperature step. Refer to FIG. 7F, which shows the metal screw gasket sealing module (a) and its sealing mechanism (b). The metal screw sealing gasket module 787 comprises the hollow metal tube, and the metal screw 785. The hollow metal tube comprises a wider tube 783 with threads, necking-down metal gasket 782, and a narrower tube 781. The metal screw comprises a metal screw head 786 and a screw body with threads 784. As shown in FIG. 7F, sealing occurs when the metal screw head 786 presses hard enough onto the necking-down metal gasket 782. The metal used for the screw head and gasket could be, but not limited to, soft metal such as copper. Such metal screw gasket sealing method can be done under ambient temperature and pressurized or vacuum environment.

Refer to FIG. 7G, which is a MEMS apparatus 770 which is very similar to the MEMS apparatus of FIG. 7C except with the addition of a metal screw gasket sealing module comprising a hollow metal tube 749 bonded hermetically to the apparatus housing using a glass seal or a metal seal followed by mechanical screwing of a metal screw 751 onto a metal gasket (not shown).

Similarly, refer to FIG. 7H, which is a MEMS apparatus 780 which is very similar to the MEMS apparatus of FIG. 7D except with the addition of a metal screw gasket sealing module comprising a hollow metal tube 774 bonded hermetically to the apparatus housing using a glass seal or a metal seal 773 followed by mechanical screwing of the metal screw 775 onto the metal gasket (not shown).

Similarly, refer to FIG. 7I, which is a MEMS apparatus 788 which is very similar to the MEMS apparatus of FIG. 7E except with the addition of a metal screw gasket sealing module comprising a hollow metal tube 774 bonded hermetically to the apparatus housing using a glass seal or a metal seal 773 followed by mechanical screwing of the metal screw 775 onto the metal gasket (not shown).

### Example #1

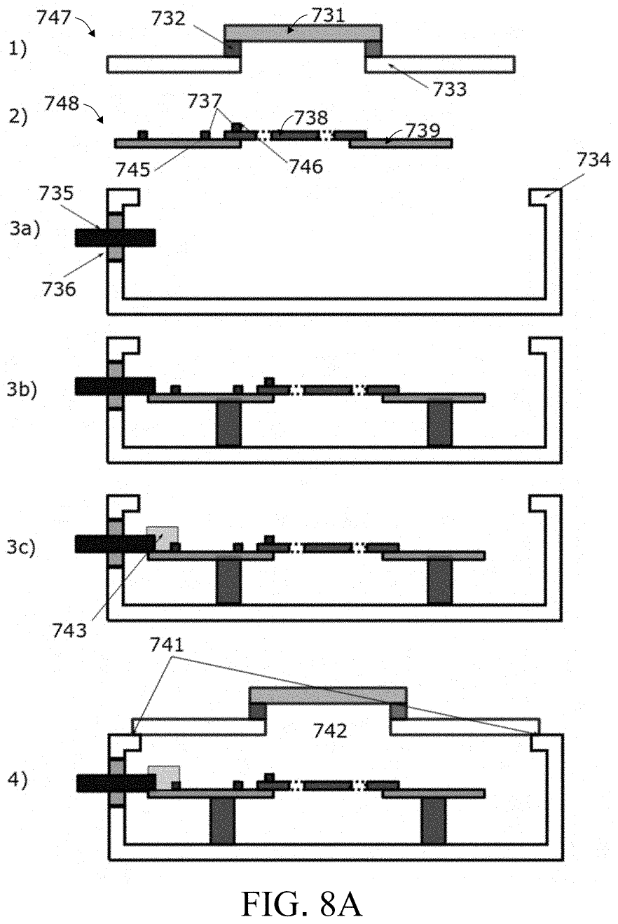

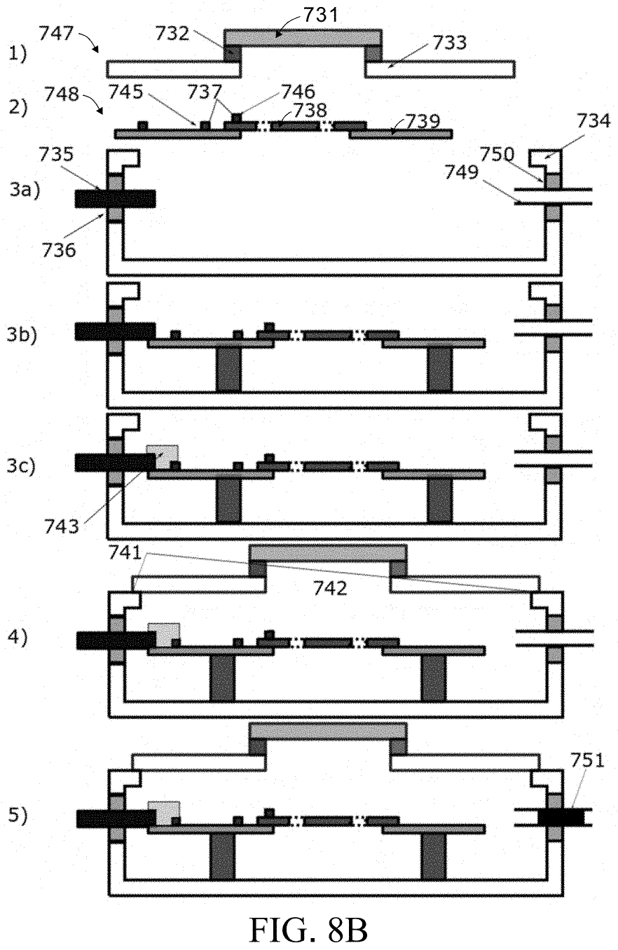

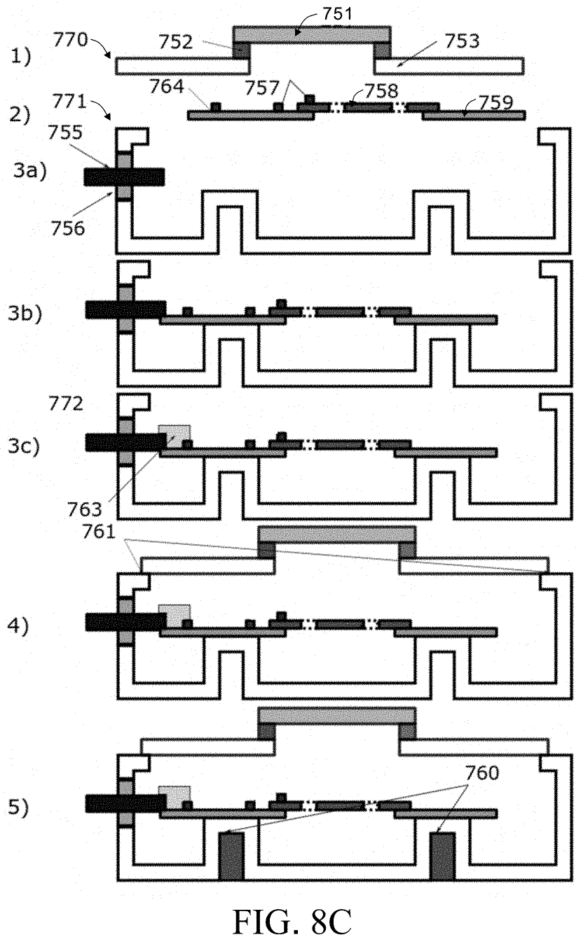

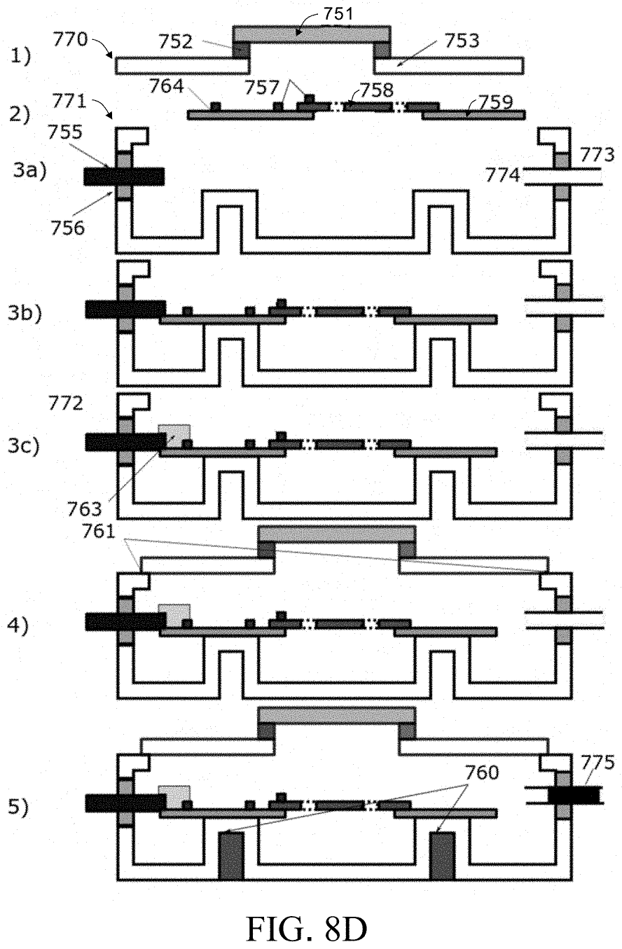

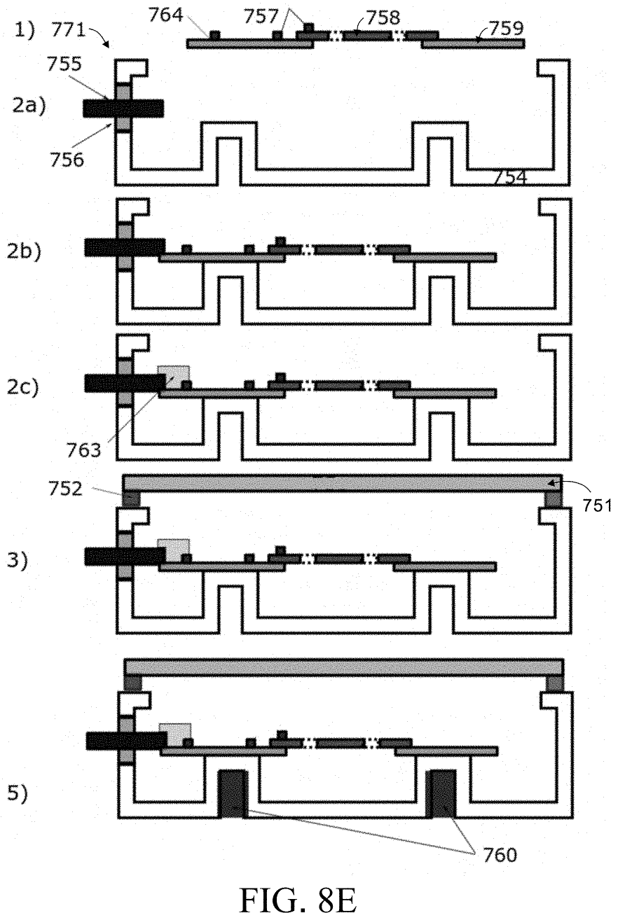

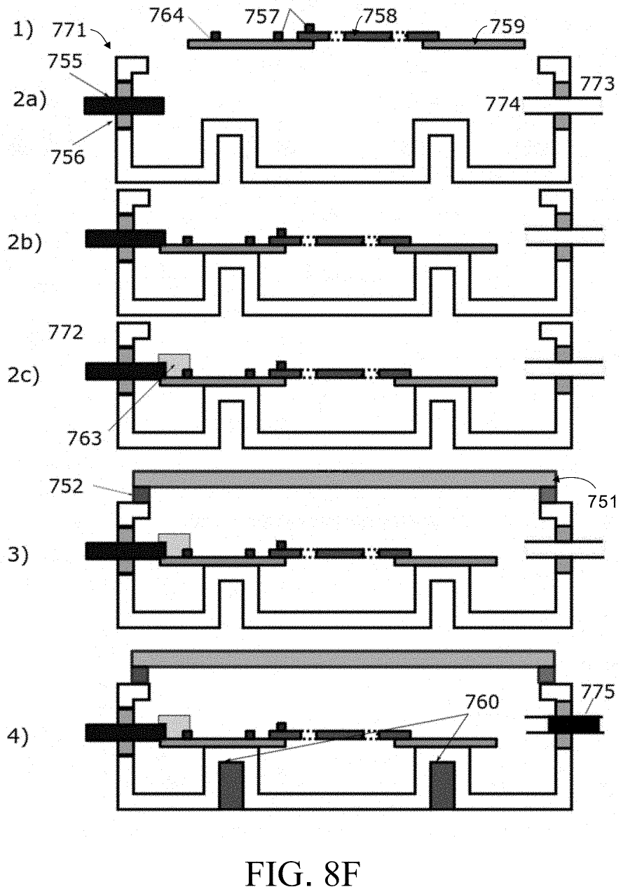

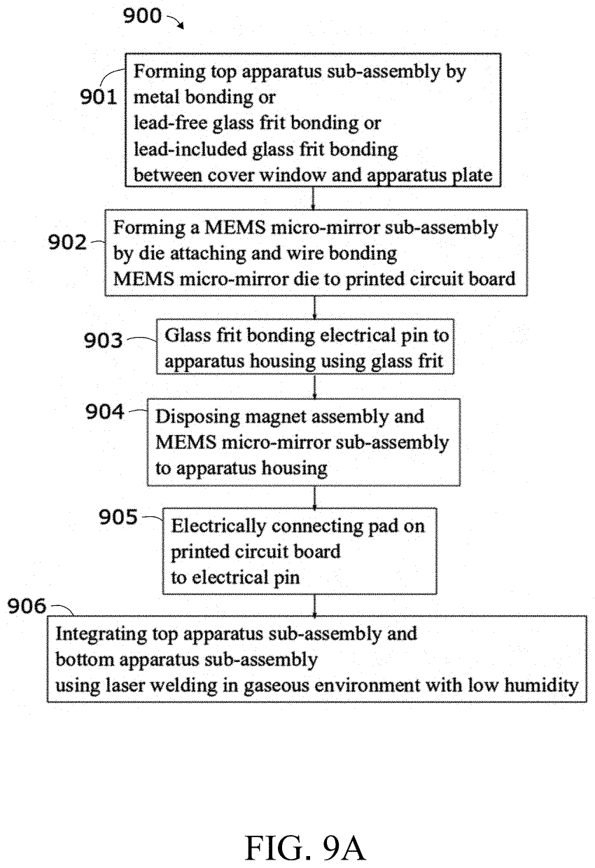

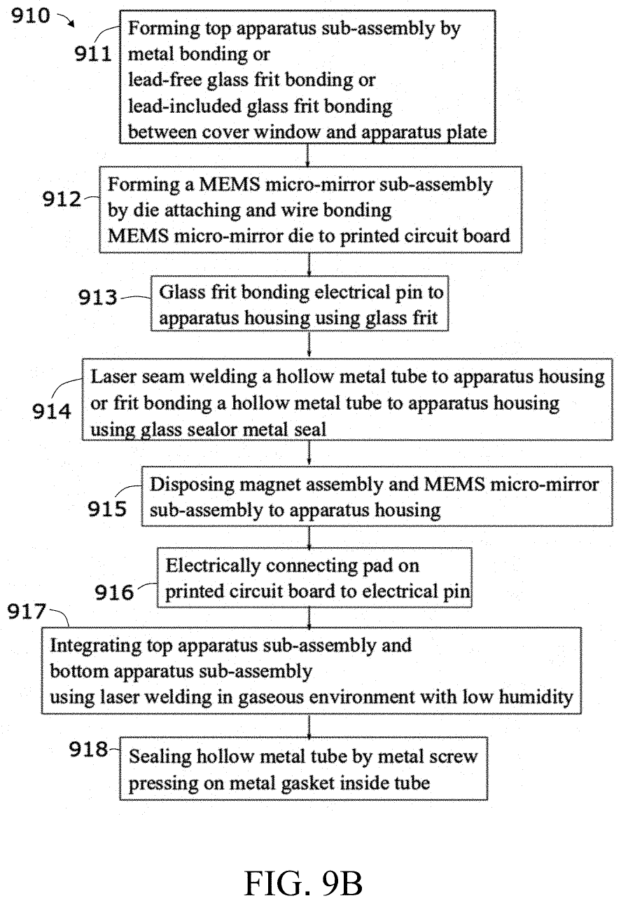

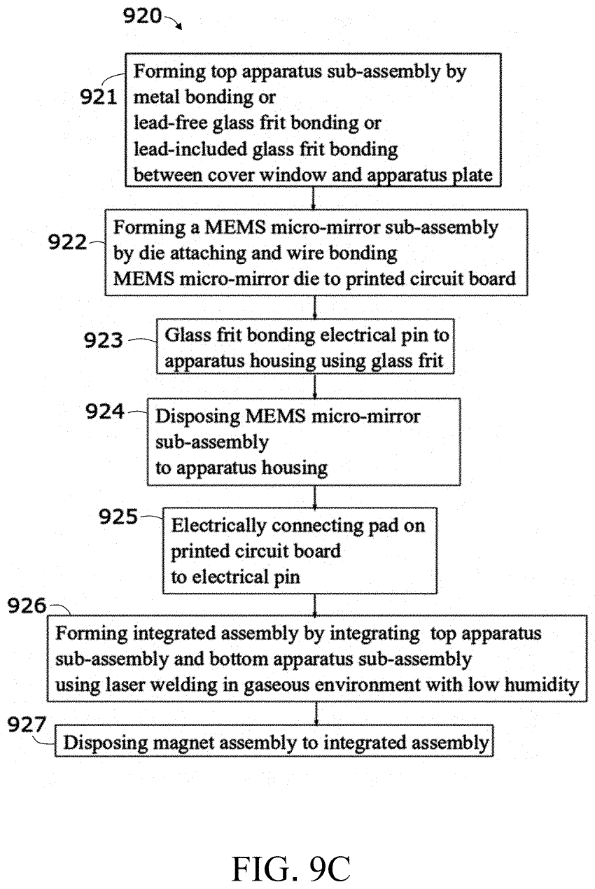

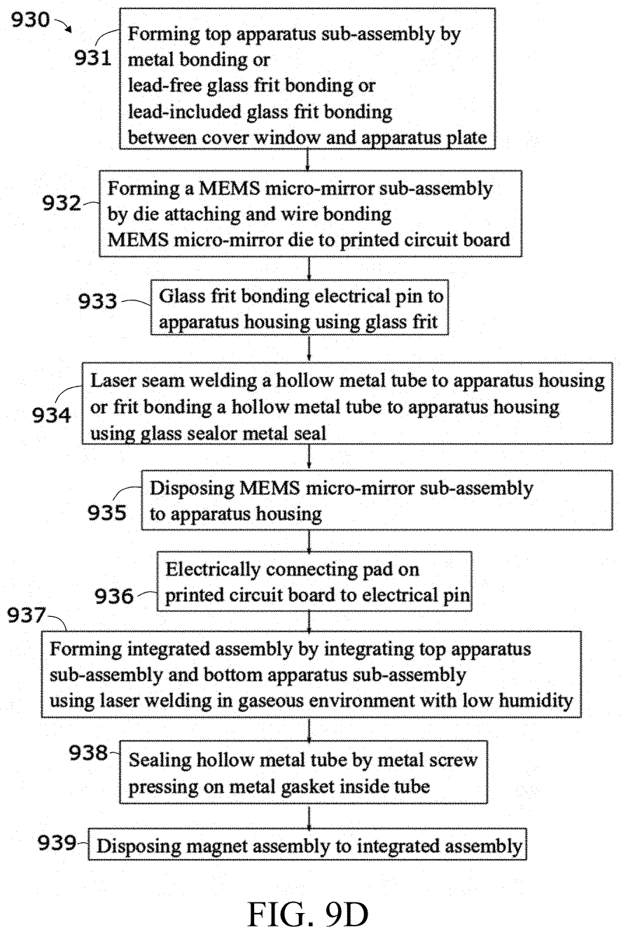

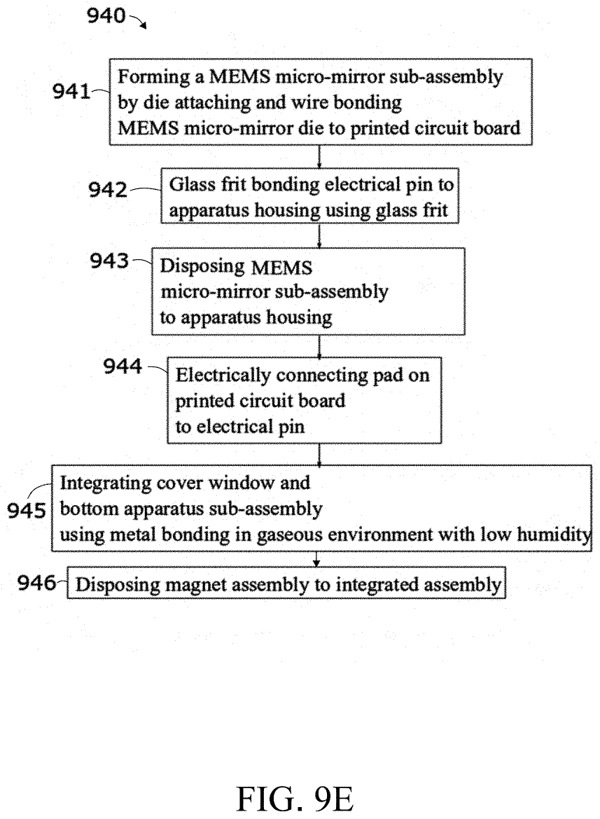

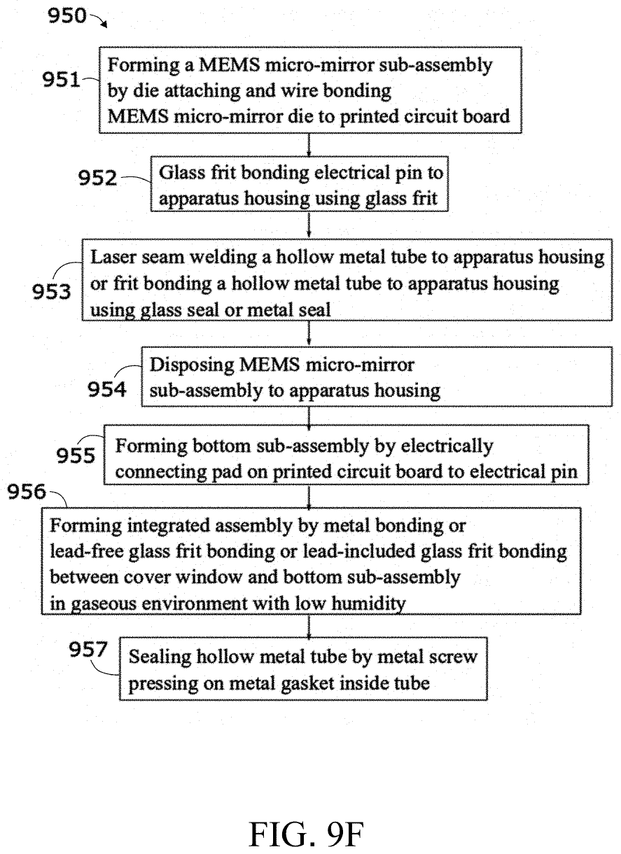

In an embodiment, the magnet assembly is completed after all high temperature bonding steps such as glass frit bonding and metal bonding, but prior to laser welding which only induces localized heating. Such heating would not damage the magnetic properties of the magnetic assembly. Refer to FIG. 8A, which is a process flow diagram showing a method of making the MEMS package of FIG. 7C and also refer to FIG. 9A, which is a flowchart showing a method (900) of making the MEMS apparatus of FIG. 7C. This method of manufacturing a hermetically sealed MEMS micro-mirror device comprises:

(Block 901) Forming a top apparatus sub-assembly 747 by metal bonding or lead-free or lead-included glass frit bonding 732 between the cover window 731 and the apparatus plate 733;

(Block 902) Forming a MEMS micro-mirror sub-assembly 748 by die attaching and wire bonding the MEMS micro-mirror die 738 to the printed circuit board 739;

Forming a bottom apparatus sub-assembly by:

(Block 903) Glass frit bonding metal pin 735 to the apparatus housing 734 using glass frit 736;

(Block 904) Disposing the magnet assembly 740 and the MEMS micro-mirror sub-assembly 748 to the apparatus housing 734;

(Block 905) Electrically connecting the pad 744 on the printed circuit board to the metal pin 706 using solder paste 743;

(Block 906) Integrating the top apparatus sub-assembly and the bottom apparatus sub-assembly using laser welding at joint 741 in a gaseous environment with low humidity.

### Example #2

In another embodiment, the magnet assembly is completed after all temperature bonding steps such as glass frit bonding, and metal bonding prior to laser seam welding. The final sealing is completed with the metal screw 751 pressing on the metal gasket.

Refer to FIG. 8B, which is a process flow diagram showing a method of making the MEMS package of FIG. 7G and also refer to FIG. 9B, which is a flowchart showing a method (910) of making the MEMS apparatus of FIG. 7G. This method of manufacturing a hermetically sealed MEMS micro-mirror device comprises:

(Block 911) Forming a top apparatus sub-assembly 747 by metal bonding or lead-free or lead-included glass frit bonding 732 between the cover window 731 and the apparatus plate 733;

(Block 912) Forming a MEMS micro-mirror sub-assembly 748 by die attaching and wire bonding the MEMS micro-mirror die 738 to the printed circuit board 739;

Forming the bottom apparatus sub-assembly by:

(Block 913) Glass frit bonding the metal pin 735 to the apparatus housing 734 using the glass seal 736;

(Block 914) Frit bonding or laser seam welding a hollow metal tube 749, not limited to copper, to the apparatus housing 734 using a seal (750) such as a glass seal or a metal seal;

(Block 915) Disposing the magnet assembly 740 and the MEMS micro-mirror subassembly 748 onto the apparatus housing 734;

(Block 916) Electrically connecting the pad 744 on the printed circuit board to the metal pin 735 using solder paste 743;

(Block 917) Integrating the top apparatus sub-assembly and the bottom apparatus sub-assembly using laser welding at joint 741 in a gaseous species environment with low humidity;

(Block 918) Sealing the hollow metal tube 749 by the metal screw 751 pressing on the metal gasket inside the metal tube 749.

### Example #3

In another embodiment, the magnet assembly is assembled after all high temperature bonding processes followed by disposing the magnet assembly outside the cavity. Refer to FIG. 8C, which is a process flow diagram showing a method of making the MEMS apparatus in FIG. 7D and also refer to FIG. 9C, which is a flowchart showing a method (920) of making the MEMS apparatus of FIG. 7D. This method of manufacturing a hermetically sealed MEMS micro-mirror device comprises:

(Block 921) Forming a top apparatus sub-assembly 770 by metal bonding 752 or lead-free glass frit bonding or lead-included glass frit bonding between the cover window 751 and the apparatus plate 753;

(Block 922) Forming a MEMS micro-mirror sub-assembly 771 by die attaching and wire bonding 757 the MEMS micro-mirror die 758 to the printed circuit board 759;

Forming a bottom apparatus sub-assembly by:

(Block 923) Glass frit bonding the metal pin 755 to the apparatus housing 754 using glass frit 756;

(Block 924) Disposing the MEMS micro-mirror subassembly 771 onto the apparatus housing 754;

(Block 925) Electrically connecting the pad 764 on the printed circuit board to the metal pin 755 using solder paste 763;

(Block 926) Integrating the top apparatus sub-assembly and the bottom apparatus sub-assembly using laser welding at joint 761 in a gaseous environment with low humidity.

(Block 927) Disposing the magnet assembly 760 to the final assembly;

### Example #4

In another embodiment, the magnet assembly is completed after all high temperature bonding steps such as glass frit bonding and metal bonding, but prior to laser welding which induces localized heating. Refer to FIG. 8D, which is a process flow diagram showing a method of making the MEMS package of FIG. 7H and also refer to FIG. 9D, which is a flowchart showing a method (930) of making the MEMS apparatus of FIG. 7H. This method of manufacturing a hermetically sealed MEMS micro-mirror device comprises:

(Block 931) Forming a top apparatus sub-assembly 770 by metal bonding 752 or lead-free glass frit bonding or lead-included glass frit bonding between the cover window 751 and the apparatus plate 753;

(Block 932) Forming a MEMS micro-mirror sub-assembly 771 by die attaching and wire bonding 757 the MEMS micro-mirror die 758 to the printed circuit board 759;

Forming a bottom apparatus sub-assembly by:

(Block 933) Glass frit bonding the metal pin 755 to the apparatus housing using glass frit 756;

(Block 934) Laser seam welding a hollow metal tube 774, not limited to copper, to the apparatus housing or glass frit bonding a hollow metal tube, not limited to copper, to the apparatus housing using a seal 773 such as a glass seal or a metal seal;

(Block 935) Disposing the MEMS micro-mirror sub-assembly 771 onto the apparatus housing;

(Block 936) Electrically connecting the pad 764 to the metal pin 755 using solder paste 763;

(Block 937) Forming an integrated assembly by integrating the top apparatus sub-assembly and the bottom apparatus sub-assembly using laser welding at joint 761 in a gaseous environment with low humidity.

(Block 938) Sealing the hollow metal tube 774 by the metal screw 775 pressing on the metal gasket inside the hollow metal tube;

(Block 939) Disposing the magnet assembly 760 onto the integrated assembly;

### Example #5

In an embodiment, the magnet assembly is completed after all high temperature bonding steps such as glass frit bonding and metal bonding, but prior to laser welding which induces localized heating. Refer to FIG. 8E, which is a process flow diagram showing a method of making the MEMS package of FIG. 7E and also refer to FIG. 9E, which is a flowchart showing a method (940) of making the MEMS apparatus of FIG. 7E. This method of manufacturing a hermetically sealed MEMS micro-mirror device comprises:

(Block 941) Forming a MEMS micro-mirror sub-assembly 771 by die attaching and wire bonding the MEMS micro-mirror die 758 to the printed circuit board 759;

Forming a bottom apparatus sub-assembly by:

(Block 942) Glass frit bonding the metal pin 755 to the apparatus housing 734 using glass frit 756;

(Block 943) Disposing the MEMS micro-mirror sub-assembly 771 to the apparatus housing 734;

(Block 944) Electrically connecting the pad 764 on the printed circuit board 759 to the metal pin 755 using solder paste 763;

(Block 945) Forming the integrated assembly by integrating the cover window 751 and the bottom apparatus sub-assembly using metal bonding 752 in a gaseous environment with low humidity;

(Block 946) Disposing the magnet assembly onto the integrated assembly.

### Example #6

In another embodiment, the magnet assembly is completed after all temperature bonding steps such as glass frit bonding, and metal bonding prior to laser seam welding. The final sealing is done with the metal screw 751 pressing on the metal gasket. Refer to FIG. 8F, which is a process flow diagram showing a method of making the MEMS package of FIG. 7I and also refer to FIG. 9F, which is a flowchart showing a method (950) of making the MEMS apparatus of FIG. 7I. This method of manufacturing a hermetically sealed MEMS micro-mirror device comprises:

(Block 951) Forming a MEMS micro-mirror sub-assembly 771 by die attaching and wire bonding the MEMS micro-mirror die 758 to the printed circuit board 759;

Forming the bottom apparatus sub-assembly by:

(Block 952) Glass frit bonding the metal pin 755 to the apparatus housing 734 using the glass seal 756;

(Block 953) Laser seam welding a hollow metal tube 774 not limited to copper to the apparatus housing 734 or frit bonding a hollow metal tube 774 to the apparatus housing using a seal (773) such as a glass seal or a metal seal;

(Block 954) Disposing the MEMS micro-mirror subassembly 771 onto the apparatus housing 734;

(Block 955) Electrically connecting the pad 764 on the printed circuit board 759 to the metal pin 755 using solder paste 763;

(Block 956) Integrating the top apparatus sub-assembly and the bottom apparatus sub-assembly by metal bonding or lead-free/lead-included glass frit bonding between the cover window and the bottom apparatus sub-assembly in a gaseous environment with low humidity;

(Block 957) Sealing the hollow metal tube 774 by the metal screw 755 pressing on the metal gasket inside the metal tube.

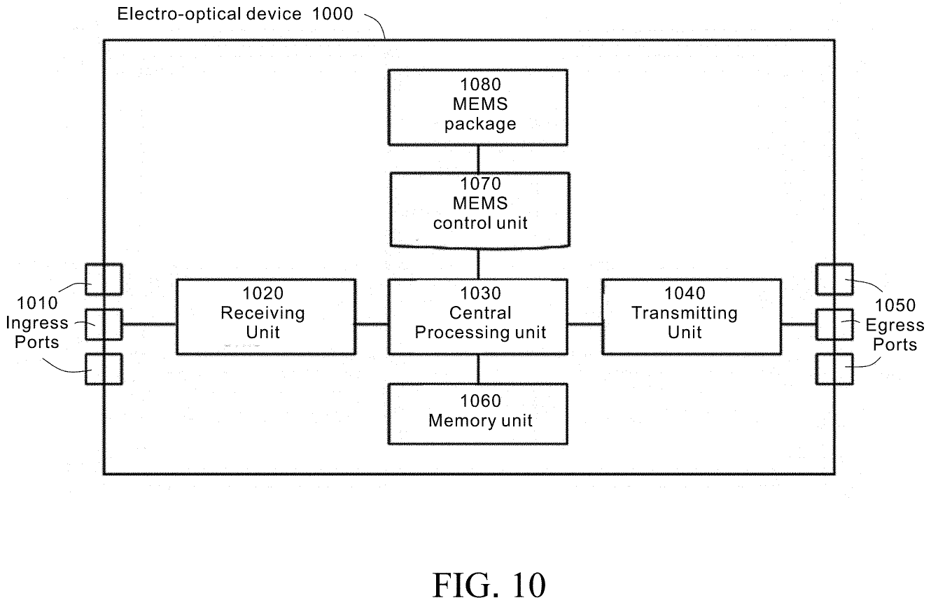

Refer to FIG. 10, which is a schematic diagram of an electro-optical device according to an embodiment of the disclosure. The electro-optical device 1000 comprises ingress ports 1010 and at least one receiving unit (Rx) 1020, a central processing unit 1030; at least one transmitting unit (Tx) 1040, egress ports 1050, a memory unit 1060, a MEMS control unit 1070, and a MEMS apparatus 1080.

The central processing unit 1030 processes data implemented by one or more computer chip(s) such as field programmable gate arrays (FPGAs), application specific integrated circuits (ASICs), digital signal processors (DSPs). The processing unit 1030 inputs data or control signals from the ingress ports 1010 through the receiving ports 1020. The processing unit 1030 also stores and retrieves data, or programs to and from memory unit 1060. The memory unit can be in form of tape drives, solid state drives, or flash memory. The memory unit could be volatile, non-volatile, read-only memory (ROM), random access memory (RAM), ternary content-addressable memory (TCAM), static random-access memory (SRAM) and a combination thereof. The unit also exports data to egress ports 1050 through a transmitting unit 1040. It communicates with the MEMS control unit 1070 which in turns controls the MEMS apparatus.

While the present disclosure has been described by means of specific embodiments, numerous modifications and variations could be made thereto by those skilled in the art without departing from the scope and spirit of the present disclosure set forth in the claims.

What is claimed is:

1. A scanning mirror apparatus comprising:
a hermetic package comprising an internal cavity;
a micro-mirror device with a reflective mirror surface disposed inside the internal cavity;
a gaseous species with predetermined index value of humidity content and pressure disposed inside the internal cavity;
an optical transparent window disposed on the hermetic package, bonded by glass frit bonding or metal bonding, covering the internal cavity, the optical transparent window containing the gaseous species inside the internal cavity; and
at least one metal pin for providing a signal, power, or ground to the micro-mirror device, attached to the hermetic package by glass frit bonding.

2. The scanning mirror apparatus of claim 1, further comprising:
a magnet assembly magnetically coupled to the micro-mirror device, wherein the magnet assembly is disposed inside the internal cavity.

3. The scanning mirror apparatus of claim 1, further comprising:
a magnet assembly magnetically coupled to the micro-mirror device, wherein the magnet assembly is disposed outside the internal cavity.

4. The scanning mirror apparatus of claim 1, wherein the predetermined index value of humidity content of the gaseous species is below 10%.

5. The scanning mirror apparatus of claim 1, wherein the predetermined index value of humidity content of the gaseous species is below 1%.

6. The scanning mirror apparatus of claim 1, wherein the predetermined index value of humidity content of the gaseous species is below 0.1%.

7. The scanning mirror apparatus of claim 1, wherein the predetermined index value of pressure level of the gaseous species is below 5 bar.

8. The scanning mirror apparatus of claim 1, wherein the predetermined index value of pressure level of the gaseous species is below 1 bar.

9. The scanning mirror apparatus of claim 1, wherein the predetermined index value of pressure level of the gaseous species is below 10 mbar.

10. The scanning mirror apparatus of claim 1, wherein the predetermined index value of pressure level of the gaseous species is below 0.1 mbar.

11. The scanning mirror apparatus of claim 1, further comprising:
a magnet assembly magnetically coupled to the micro-mirror device, wherein the magnet assembly comprises a plurality of individual magnets.

12. The scanning mirror apparatus of claim 1, wherein the micro-mirror device comprises a plurality of micro-mirrors.

13. The scanning mirror apparatus of claim 1, further comprising:
a substrate; and
at least one flexure coupled with the substrate and the micro-mirror device, the at least one flexure allowing the micro-mirror device to rotate about the at least one flexure.

14. The scanning mirror apparatus of claim 13, further comprising:
a magnet assembly magnetically coupled to the micro-mirror device, the magnetic assembly configured to generate a magnetic field substantially perpendicular to an axis of rotation of the at least one flexure; and
at least one coil fixed to the micro-mirror device, wherein when a current is applied to the at least one coil, the micro-mirror device and the at least one coil rotate about the at least one flexure.

15. The scanning mirror apparatus of claim 13, further comprising:
at least one angle sensor disposed on the flexure and configured to measure an angle of rotation of the micro-mirror device about the at least one flexure.

16. The scanning mirror apparatus of claim 15, wherein the at least one angle sensor comprises a piezo-resistive sensor or a plurality of piezo-resistive elements coupled in a Wheatstone bridge circuit or a Hall-effect sensor.

17. The scanning mirror apparatus of claim 1, further comprising:
a gimbal;
at least one first flexure coupled with the micro-mirror device and the gimbal allowing the micro-mirror device and the gimbal to rotate about the at least one first flexure;
a substrate; and
at least one second flexure coupled with the gimbal and the substrate allowing the micro-mirror device and the gimbal to rotate about the at least one second flexure;
wherein the at least one second flexure is substantially orthogonal to the at least one first flexure.

18. The scanning mirror apparatus of claim 17, further comprising:
a magnet assembly magnetically coupled to the micro-mirror device, wherein the magnetic assembly is configured to generate a first magnetic field substantially perpendicular to an axis of rotation of the at least one first flexure and a second magnetic field substantially perpendicular to an axis of rotation of the at one second flexure;
at least one first coil fixed to the micro-mirror device, wherein when a first current is applied to the at least one first coil, the micro-mirror device and the at least one first coil rotate about the first flexure; and
at least one second coil fixed to the gimbal, wherein when a second current is applied to the at least one second coil, the micro-mirror device, the gimbal, and the at least one second coil rotate about the second flexure.

19. The scanning mirror apparatus of claim 17, further comprising:
a first angle sensor disposed on the first flexure configured to measure a first angle of rotation of the micro-mirror device about the first flexure; and
a second angle sensor disposed on the second flexure configured to measure a second angle of rotation of the micro-mirror device about the second flexure.

20. The scanning mirror apparatus of claim 19, wherein the first and second angle sensor comprises a piezo-resistive sensor or a plurality of piezo-resistive elements coupled in a Wheatstone bridge circuit or a Hall-effect sensor.

21. The scanning mirror apparatus of claim 1, wherein the hermetic package comprises a plurality of hermetic package pieces bonded together by welding.

22. The scanning mirror apparatus of claim 1, wherein the hermetic package comprises nickel iron alloy or ceramic.

23. The scanning mirror apparatus of claim 22, wherein the nickel iron alloy comprises ASTM F15 alloy, 52 alloy, 48 alloy, 46 alloy, 42 alloy, or 36 alloy.

24. The scanning mirror apparatus of claim 22, wherein the ceramic comprises alumina, aluminum nitride, silicon carbide, or silicon nitride.

25. The scanning mirror apparatus of claim 1, wherein the optical transparent window comprises borosilicate glass, silica glass quartz, sapphire, borosilicate glass, borosilicate crown glass, or soda-lime glass.

26. The scanning mirror apparatus of claim 1, wherein the optical transparent window is transparent to ultraviolet light 340-400 nm, visible light, infra-red 840 nm, 905 nm, 940 nm, 1310 nm, 1550 nm, or 3-5 μm, 7.5-14 μm wavelengths.

27. The scanning mirror apparatus of claim 1, wherein the glass frit bonding comprises lead-free glass frit bonding or lead-included glass frit bonding.

28. The scanning mirror apparatus of claim 1, wherein the metal bonding comprises metal diffusion bonding of copper-copper 250-400° C., gold-gold 250-400° C., titanium-titanium 300-400° C., aluminum-aluminum 400-480° C., silicon-titanium or metal eutectic bonding of Indium-Tin 118° C., gold indium 180-210° C., copper-tin 240-270° C., gold-tin 280-310° C., gold-germanium 380-400° C., gold-silicon 390-415° C., aluminum-germanium 430-450° C., or gold-copper 450-485° C.

29. The scanning mirror apparatus of claim 17, wherein the micro-mirror device comprises at least one electrostatic driven micro-electro-mechanical systems (MEMS) micro-mirror further comprising:
a plurality of first conductive pads electrically coupled to the micro-mirror;
a plurality of second conductive pads electrically coupled to the gimbal;
wherein when an AC voltage is applied to the plurality of second conductive pads, the micro-mirror rotates about the at least one second flexure while the gimbal is connected to electrical ground; and
wherein when another AC voltage is applied to the plurality of first conductive pads, the scanning mirror rotates about the at least one first flexure.

30. The scanning mirror apparatus of claim 17, wherein the micro-mirror device comprises at least one piezo-electric driven micro-electro-mechanical systems (MEMS) micro-mirror further comprising:
a first piezoelectric actuator such that when a first AC voltage of substantially close to resonant frequency is applied to the first piezoelectric actuator, the micro-mirror rotates about the first flexure; and
a second piezoelectric actuator such that when a second AC voltage of substantially close to resonant frequency is applied to the second piezoelectric actuator, the micro-mirror rotates about the second flexure.

31. The scanning mirror apparatus of claim 17, further comprising:
a magnet assembly magnetically coupled to the micro-mirror device, wherein the magnetic assembly is configured to generate a first magnetic field substantially perpendicular to an axis of rotation of the at least one first flexure and a second magnetic field substantially perpendicular to an axis of rotation of the at one second flexure;
at least one first coil fixed to the gimbal, wherein when a first current is applied to the at least one first coil, the micro-mirror device and the at least one first coil rotate about the first flexure; and
at least one second coil fixed to the gimbal, wherein when a second current is applied to the at least one second coil, the micro-mirror device, the gimbal, and the at least one second coil rotate about the second flexure.

32. The scanning mirror apparatus of claim 17, further comprising:
a magnet assembly magnetically coupled to the micro-mirror device, wherein the magnetic assembly is configured to generate a first magnetic field substantially perpendicular to an axis of rotation of the at least one first flexure and a second magnetic field substantially perpendicular to an axis of rotation of the at one second flexure; and
at least one coil fixed to the gimbal, wherein when a first current is applied to the at least one coil, the micro-mirror device and the at least one coil rotate about the first flexure; and when a second current is also applied to the at least one coil, the micro-mirror device, the gimbal, and the at least one coil rotate about the second flexure.

33. The scanning mirror apparatus of claim 1, further comprising a moisture absorption moiety.

34. The scanning mirror apparatus of claim 33, wherein the moisture absorption moiety comprises silica gel, molecular sieve, calcium chloride, calcium montmorillonite, H2O getter, Zirconium alloy, calcium oxide or combination thereof.

35. A method of making a scanning mirror apparatus, the method comprising:
providing a hermetic package having an internal cavity formed therein;
disposing a micro-mirror device with a reflective mirror surface disposed inside the internal cavity;
disposing a gaseous species with predetermined index value of humidity content and pressure disposed inside the internal cavity;
disposing an optical transparent window disposed on the hermetic package bonded by glass frit bonding or metal bonding covering the internal cavity, the optical transparent window containing the gaseous species inside the internal cavity; and
disposing at least one metal pin for providing a signal, power, or ground to the micro-mirror device, attached to the hermetic package by glass frit bonding.

36. The method of claim 35, wherein the scanning mirror apparatus further comprises:
a magnet assembly magnetically coupled to the micro-mirror device, wherein the magnet assembly is disposed inside the internal cavity.

37. The method of claim 35, wherein the scanning mirror apparatus further comprises:
a magnet assembly magnetically coupled to the micro-mirror device, wherein the magnet assembly is disposed outside the internal cavity.

38. The method of claim 35, wherein the predetermined index value of pressure level of the gaseous species is below 5 bar.

39. The method of claim 35, wherein the scanning mirror apparatus further comprises:
a substrate; and
at least one flexure coupled with the substrate and the micro-mirror device, the at least one flexure allowing the micro-mirror device to rotate about the at least one flexure.

40. The method of claim 39, wherein the scanning mirror apparatus further comprises:
a magnet assembly magnetically coupled to the micro-mirror device, the magnetic assembly configured to generate a magnetic field substantially perpendicular to an axis of rotation of the at least one flexure; and
at least one coil fixed to the micro-mirror device, wherein when a current is applied to the at least one coil, the micro-mirror device and the at least one coil rotate about the at least one flexure.

41. The method of claim 39, wherein the scanning mirror apparatus further comprises:
at least one angle sensor disposed on the flexure and configured to measure an angle of rotation of the micro-mirror device about the at least one flexure.

42. The method of claim 41, wherein the at least one angle sensor comprises a piezo-resistive sensor or a plurality of piezo-resistive elements coupled in a Wheatstone bridge circuit or a Hall-effect sensor.

43. The method of claim 35, wherein the scanning mirror apparatus further comprises:
a gimbal;
at least one first flexure coupled with the micro-mirror device and the gimbal allowing the micro-mirror device and the gimbal to rotate about the at least one first flexure;
a substrate; and
at least one second flexure coupled with the gimbal and the substrate allowing the micro-mirror device and the gimbal to rotate about the at least one second flexure;
wherein the at least one second flexure is substantially orthogonal to the at least one first flexure.

44. The method of claim 43, wherein the scanning mirror apparatus further comprises:
a magnet assembly magnetically coupled to the micro-mirror device, wherein the magnetic assembly is configured to generate a first magnetic field substantially perpendicular to an axis of rotation of the at least one first flexure and a second magnetic field substantially perpendicular to an axis of rotation of the at one second flexure;
at least one first coil fixed to the micro-mirror device, wherein when a first current is applied to the at least one first coil, the micro-mirror device and the at least one first coil rotate about the first flexure; and
at least one second coil fixed to the gimbal, wherein when a second current is applied to the at least one second coil, the micro-mirror device, the gimbal, and the at least one second coil rotate about the second flexure.

45. The method of claim 43, wherein the scanning mirror apparatus further comprises:
a first angle sensor disposed on the first flexure configured to measure a first angle of rotation of the micro-mirror device about the first flexure; and
a second angle sensor disposed on the second flexure configured to measure a second angle of rotation of the micro-mirror device about the second flexure.

46. The method of claim 35, wherein the hermetic package comprises a plurality of hermetic package pieces bonded together by welding.

47. The method of claim 35, wherein the metal bonding comprises metal diffusion bonding of copper-copper 250-400° C., gold-gold 250-400° C., titanium-titanium 300-400° C., aluminum-aluminum 400-480° C., silicon-titanium or metal eutectic bonding of Indium-Tin 118° C., gold indium 180-210° C., copper-tin 240-270° C., gold-tin 280-310° C., gold-germanium 380-400° C., gold-silicon 390-415° C., aluminum-germanium 430-450° C., or gold-copper 450-485° C.

48. The method of claim 43, wherein the micro-mirror device comprises at least one electrostatic-driven micro-electro-mechanical systems (MEMS) micro-mirror further comprising:
a plurality of first conductive pads electrically coupled to the micro-mirror, corresponding counterparts of the first conductive pads electrically coupled to the gimbal; and
a plurality of second conductive pads electrically coupled to the gimbal;
wherein when an AC voltage is applied to the plurality of second conductive pads, the micro-mirror rotates about the second flexure while the gimbal is connected to electrical ground; and
wherein when another AC voltage is applied to the first conductive pads, the micro-mirror rotates about the first flexure.

49. The method of claim 43, wherein the micro-mirror device comprises at least one piezo-electric driven micro-electro-mechanical systems (MEMS) micro-mirror further comprising:
a first piezoelectric actuator such that when a first AC voltage of substantially close to resonant frequency is applied to the first piezoelectric actuator, the micro-mirror rotates about the first flexure; and
a second piezoelectric actuator such that when a second AC voltage of substantially close to resonant frequency is applied to the second piezoelectric actuator, the micro-mirror rotates about the second flexure.

50. The method of claim 43, wherein the scanning mirror apparatus further comprises:
a magnet assembly magnetically coupled to the micro-mirror device, wherein the magnetic assembly is configured to generate a first magnetic field substantially perpendicular to an axis of rotation of the at least one first flexure and a second magnetic field substantially perpendicular to an axis of rotation of the at least one second flexure;
at least one first coil fixed to the gimbal, wherein when a first current is applied to the at least one first coil, the micro-mirror device and the at least one first coil rotate about the at least one first flexure; and
at least one second coil fixed to the gimbal, wherein when a second current is applied to the at least one second coil, the micro-mirror device, the gimbal, and the at least one second coil rotate about the at least one second flexure.

51. The method of claim 43, wherein the scanning mirror apparatus further comprises:
a magnet assembly magnetically coupled to the micro-mirror device, wherein the magnetic assembly is configured to generate a first magnetic field substantially perpendicular to an axis of rotation of the at least one first flexure and a second magnetic field substantially perpendicular to an axis of rotation of the at one second flexure; and
at least one coil fixed to the gimbal, wherein when a first current is applied to the at least one coil, the micro-mirror device and the at least one coil rotate about the at least one first flexure; and when a second current is also applied to the at least one coil, the micro-mirror device, the gimbal, and the at least one coil rotate about the at least one second flexure.

52. The method of claim 35, wherein the scanning mirror apparatus further comprises a moisture absorption moiety.
